(19) United States
(12) Patent Application Publication
(10) Pub. No.: US 2014/0329194 A1
(43) Pub. Date: Nov. 6, 2014

(54) ORTHODONTIC TREATMENT PLANNING USING BIOLOGICAL CONSTRAINTS

(71) Applicants: Rohit Sachdeva, Plano, TX (US); Peer Sporbert, Berlin (DE)

(72) Inventors: Rohit Sachdeva, Plano, TX (US); Peer Sporbert, Berlin (DE)

(21) Appl. No.: 13/887,323

(22) Filed: May 5, 2013

(51) Int. Cl. A61C 7/00

(52) U.S. Cl. CPC A61C 7/002; A61C 2007/004
USPC 433/24

(57) ABSTRACT

The invention relates to planning orthodontic treatment for a patient, including surgery, using biological constrains such as those arising from bone, soft tissue, and roots of patient's teeth. The invention disclosed herein provides capability to vary the movement ratio between the teeth and bone and soft tissue through treatment simulation to assess the risk factor associated with a particular treatment plan. The invention further provides capability to monitor results of the treatment to determine the actual movement ratio between the teeth and bone and soft tissue and update the database. Additionally, a method and apparatus are disclosed enabling an orthodontist or a user to create an unified three dimensional virtual craniofacial and dentition model of actual, as-is static and functional anatomy of a patient, from data representing facial bone structure; upper jaw and lower jaw; facial soft tissue; teeth including crowns and roots; information of the position of the roots relative to each other; and relative to the facial bone structure of the patient; obtained by scanning as-is anatomy of craniofacial and dentition structures of the patient with a volume scanning device; and data representing three dimensional virtual models of the patient's upper and lower gingiva, obtained from scanning the patient's upper and lower gingiva either (a) with a volume scanning device, or (a) with a surface scanning device. Such craniofacial and dentition models of the patient can be used in optimally planning treatment of a patient.

### CROSS-REFERENCE TO RELATED APPLICATIONS

This application is a non-provisional application corresponding to the provisional application Ser. No. 61/642,646, filed May 4, 2012, pending.

The subject matter of this application is related to the subject matter of the following applications. Priority to the related applications is not claimed under 35 U.S.C. §120.

Application Ser. No. 12/772,208, filed May 1, 2010, pending;

Application Ser. No. 09/834,593, filed Apr. 13, 2001, now issued as U.S. Pat. No. 7,068,825;

Application Ser. No. 09/835,007, filed Apr. 13, 2001, now issued as U.S. Pat. No. 7,027,642;

Application Ser. No. 09/834,413, filed Apr. 13, 2001, now issued as U.S. Pat. No. 7,080,979;

Application Ser. No. 09/835,039, filed Apr. 13, 2001, now issued as U.S. Pat. No. 6,648,640;

Application Ser. No. 09/834,593, filed Apr. 13, 2001, now issued as U.S. Pat. No. 7,068,825;

Application Ser. No. 10/429,123, filed May 2, 2003, now issued as U.S. Pat. No. 7,234,937; and

Application Ser. No. 10/428,461, filed May 2, 2003, pending, which is a continuation-in-part of application Ser. No. 09/834,412, filed Apr. 13, 2001, now issued as U.S. Pat. No. 6,632,089.

The entire contents of each of the above listed patent application are incorporated by reference herein.

### BACKGROUND OF THE INVENTION

A. Field of the Invention

This invention relates generally to the field of orthodontics. More particularly, the invention relates to planning orthodontic treatment for a patient, including surgery, using biological constrains such as those arising from bone, soft tissue, and roots of patient's teeth.

B. Description of Related Art

Current challenge is that orthodontic treatment doesn't account for biological response, and therefore unpredictable and uncontrolled treatment response can occur, and it can also be destructive to the tissue leading to ill effects, delay in achieving treatment objective and additional interventions to correct the problem might be required. Also poor outcomes and unstable result may occur.

In orthodontics, a patient suffering from a malocclusion is typically treated by bonding brackets to the surface of the patient's teeth. The brackets have slots for receiving an archwire. The bracket-archwire interaction governs forces applied to the teeth and defines the desired direction of tooth movement. Typically, the bends in the wire are made manually by the orthodontist. During the course of treatment, the movement of the teeth is monitored. Corrections to the bracket position and/or wire shape are made manually by the orthodontist.

The key to efficiency in treatment and maximum quality in results is a realistic simulation of the treatment process. Today's orthodontists have the possibility of taking plaster models of the upper and lower jaw, cutting the model into single tooth models and sticking these tooth models into a wax bed, lining them up in the desired position, the so-called set-up. This approach allows for reaching a perfect occlusion without any guessing. The next step is to bond a bracket at every tooth model. This would tell the orthodontist the geometry of the wire to run through the bracket slots to receive exactly this result. The next step involves the transfer of the bracket position to the original malocclusion model. To make sure that the brackets will be bonded at exactly this position at the real patient's teeth, small templates for every tooth would have to be fabricated that fit over the bracket and a relevant part of the tooth and allow for reliable placement of the bracket on the patient's teeth. To increase efficiency of the bonding process, another option would be to place each single bracket onto a model of the malocclusion and then fabricate one single transfer tray per jaw that covers all brackets and relevant portions of every tooth. Using such a transfer tray guarantees a very quick and yet precise bonding using indirect bonding.

However, it is obvious that such an approach requires an extreme amount of time and labor and thus is too costly, and this is the reason why it is not practiced widely. The normal orthodontist does not fabricate set-ups; he places the brackets directly on the patient's teeth to the best of his knowledge, uses an off-the-shelf wire and hopes for the best. There is no way to confirm whether the brackets are placed correctly; and misplacement of the bracket will change the direction and/or magnitude of the forces imparted on the teeth. While at the beginning of treatment things generally run well as all teeth start to move at least into the right direction, at the end of treatment a lot of time is lost by adaptations and corrections required due to the fact that the end result has not been properly planned at any point of time. For the orthodontist this is still preferable over the lab process described above, as the efforts for the lab process would still exceed the efforts that he has to put in during treatment. And the patient has no choice and does not know that treatment time could be significantly reduced if proper planning was done.

U.S. Pat. No. 5,431,562 to Andreiko et al. describes a computerized, appliance-driven approach to orthodontics. In this method, first certain shape information of teeth is acquired. A uniplanar target archform is calculated from the shape information. The shape of customized bracket slots, the bracket base, and the shape of an orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target archform and appliance design. Hence the '562 patent teaches away from an interactive, computer-based system in which the orthodontist remains fully involved in patient diagnosis, appliance design, and treatment planning and monitoring.

More recently, in the late 1990's Align Technologies began offering transparent, removable aligning devices as a new treatment modality in orthodontics. In this system, a plaster model of the dentition of the patent is obtained by the orthodontist and shipped to a remote appliance manufacturing center, where it is scanned with a laser. A computer model of the dentition in a target situation is generated at the appliance manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

U.S. Pat. No. 6,632,089 to Rubbert discloses an interactive, software-based treatment planning method to correct a malocclusio. The method can be performed on an orthodontic workstation in a clinic or at a remote location such as a lab or precision appliance manufacturing center. The workstation stores a virtual three-dimensional model of the dentition of a patient and patient records. The virtual model is manipulated by the user to define a target situation for the patient, including a target archform and individual tooth positions in the archform. Parameters for an orthodontic appliance, such as the location of orthodontic brackets and resulting shape of a customized orthodontic archwire, are obtained from the simulation of tooth movement to the target situation and the placement position of virtual brackets.

The key to planning optimal orthodontic, other and oral treatments is obtaining three dimensional images of actual roots of teeth of a patient. Practitioners have produced three dimensional models of roots for treatment planning from x-rays and tooth templates; however, there is no assurance that such three dimensional models of roots do really represent the anatomy of actual roots.

Suzanne U. McCornick and Stephanie J, Drew in an article published in Journal of Oral and Maxillofacial Surgery, “Virtual Model Surgery for Efficient Planning and Surgical Performance”, published March 2011, Vol. 69, Number 3, pp. 638-644, disclose a modeling technique for creating a three dimensional computer based model of a patient for planning treatment for a patient. Their approach requires overlaying digital dental models obtained from a laser surface scanner over the CT/CBCT scan and align the skeletal components into natural head position using an orientation sensor. The laser scan model is obtained by scanning a stone model of the patient's teeth. Also a bite fork, with a face bow with radiographic markers, is used to obtain the information regarding the bite of the patient. While this approach shows some promising possibilities, it basically requires fusion of models produced by various devices in to a single composite model. The authors did not disclose any method for producing a three dimensional model of the patient's dentition enabling creation of three dimensional images of the patient's tooth roots.

In orthodontic treatment planning, virtual models of the dentition of a patient play a key role and are extremely important. By-and-large so far the models created from surface scan are used. These models lack in the areas or roots, bones and soft tissues. Therefore a need exists to for the virtual three dimensional models of dentition including tooth roots and surrounding anatomy which can be used in planning orthodontic treatment based upon very important information concerning three dimensional anatomy of craniofacial and dentition structures of a patient. Furthermore, a need for more realistic treatment planning exists that reflects the patient specific biological response to the treatment, enables the design of the proper orthodontic appliance systems, and provides necessary monitoring schedule. The present invention meets this need.

### SUMMARY OF THE INVENTION

Orthodontic tooth movement (OTM) is a result of two interrelated events 1) bending of alveolar bone and 2) remodeling of the periodontal tissues. These events are triggered through the application of mechanical forces to the tooth. Disregard of the interaction between the applied orthodontic forces, the type of tooth movement and the anatomical constraints may lead to unfavorable sequel such as bone loss, gingival recession or root resorption. Therefore, an understanding of the nature of the interaction between these factors and their influence on the biological response is vital to ensure predictable and stable treatment outcomes.

The present invention has 3 main components: Diagnostic, Prognostic and therapeutic using visualization, simulation, and 3D images.

Diagnostic: Nature of anomaly compared against internal control as well as normative data base.

Measures include shape and size volume of maxillary and mandibular alveolar processes. Quality of bone. Thickness of cortical bone and extent. Same for soft tissue and tooth measures crown root. All this at any level of the craniofacial skeleton. Size matching at any level to understand nature of the problem. Mechanical data can be added eg youngs modulus, genotype or history of response etc Phenotype, biotype, genotype plot reponse to stress field Registery

Simulations driven by nature of tooth movement, region, and anticipated response based upon published studies or monitoring patient response at soft tissue, dental, bony level.

Expect 1:1 displacement doesn't occur. Reality displacement ratio maybe 1:0.8. Simulate modeling and remodeling change ie shape. Also shape change driven by direction, type of movement, region, amount of movement, speed of movement.simlate time dependant rate of modeling and other risk factors such as alveolar bone morphology

Sliders to set limits in software plus visualization tools

Changes can override interactively or limits can be set by operator based upon clinical monitoring of patient

Physical constraints also modeled.

Eg palatal wall of maxilla doesn't respond to forces so can change resistance locally, while in less dense bone less resistance

Can define any crot for tooth movement or bone or soft tissue

Can model high risk for recession or bone defect or root resorption. Risk analysis can be done automatically.

Therapeutic appliance approach designed to condition and respond to the patient's needs.

### BRIEF DESCRIPTION OF THE DRAWINGS

Presently preferred embodiments of the invention are described below in reference to the appended drawings, wherein like reference numerals refer to like elements in the various views, and in which:

FIG. 1 is block diagram of a system for creating a three-dimensional virtual patient model and for diagnosis and planning treatment of the patient.

FIGS. 2A and 2B show two different patients, one with short facial height (Hypodivergent), and another with long facial height (Hyperdivergent), respectively.

FIGS. 2C-2E show a Hypodivergent patient's facial skeleton; with FIG. 2C showing the front facial view, FIG. 2D showing a lateral view and FIG. 2D showing a segital cross-sectional view.

FIGS. 2F-2H, similarly, show a Hyperdivergent patient's facial skeleton; with FIG. 2F showing the front facial view, FIG. 2G showing a lateral view and FIG. 2H showing a segital cross-sectional view.

FIGS. 2I-2J show another view of a Hypodivergent patient's facial skeleton, with FIG. 2I showing a mandibular or lower occlusal view, and FIG. 2J showing a maxilla or upper occlusal view.

FIGS. 2K-2L, similarly, show another view of a Hyperdivergent patient's facial skeleton, with FIG. 2K showing a mandibular or lower occlusal view, and FIG. 2L showing a maxilla or upper occlusal view.

FIG. 3A shows Dehiscence viewed on CBCT; whereas FIG. 3B shows Dehiscence viewed on a CBCT surface volume rendered image.

FIG. 4A shows Fenestration viewed on CBCT; whereas FIG. 4B shows Fenestration viewed on a CBCT surface volume rendered image.

FIG. 5A shows a pretreatment cephalometrics model of a patient; and FIG. 5B shows the mid-treatment cephalometrics model of the same patient. Note that the lower incisors in FIG. 5B have been severely proclined a result of leveling and use of Class II elastics.

FIGS. 6A, 6B and 6C show dehiscence associated with flaring of incisors of a patient. The models show initial condition of the patient. FIG. 6A shows the labial view, FIG. 6B the occlusal view and FIG. 6C the lateral view of the dentition of the patient. The figures demonstrate mild to moderate crowding in the lower arch of the patient in a deep curve of Spee.

FIGS. 6D, 6E, 6F, 6G and 6H show post treatment alignment and leveling of the teeth of the patient. FIG. 6D shows the labial view, FIG. 6E the occlusal view and FIG. 6F the lateral view of the dentition of the patient. FIG. 6G shows the occlusal view with the after treatment image supper imposed on the image prior to the treatment. FIG. 6H shows an enlarged version of a portion of the view in FIG. 6G. Notice the fenestrations that have developed in lower anterior region as the incisors were tipped forward.

FIGS. 6I-6J show single tooth view of the left mandibular central incisor of the patient. Note that the lower incisor has proclined and moved out of the anterior limits of the mandibular alveolar process. FIGS. 6K-6L show a significant amount of proclination that has occurred with respect to the original incisor position.

FIGS. 6M-6P show the displacement of the lower left lateral incisor. Note the greater amount of tipping that has occurred. This appears to be related to the creation of a larger bone defect.

FIG. 7A numeral 250, FIG. 7B numeral 270 and FIG. 7C numeral 275 show patient's images prior to orthodontic treatment. FIG. 7A numeral 255 shows patient's RME image. FIG. 7A numeral 260, FIG. 7B numeral 280 and FIG. 7C numeral 285 show patient's images after the orthodontic treatment. FIG. 7B numeral 270 and FIG. 7C numeral 275 show models created from using a surface scanning device, whereas FIG. 7B numeral 280 and FIG. 7C numeral 285 show models created from combination of images created from a surface scanning device and a volume scanning device such as CBCT. FIG. 7B numeral 280 and FIG. 7C numeral 285 show models with roots showing excessive buccal root tipping as a result of RME. Such tooth movement results in high stresses at the cervical bone margins of the crowns which may promote bone loss.

FIGS. 8A-8G show images of palatal cortex response to retraction for a patient. FIGS. 8A-8C show pretreatment images. FIGS. 8D-8F show mid-treatment images with bicuspid extractions. Note, as upper incisors are retracted bone dehiscence in the palatal cortex area is observed. This is not seen clinically or cephalometrically, but, can be seen with a CBCT image. FIG. 8G shows superimposition of initial on the mid treatment images. Note, bone dehiscence in response to upper incisor retraction.

FIGS. 9A-9J show images used in treatment simulation of a patient. Treatment planning software in conjunction with the workstation is used to identify potential risks associated with tooth movement proactively. FIG. 9A shows the initial model. FIG. 9B shows image of retraction simulated with controlled tipping. FIG. 9C shows superimposition of images in FIGS. 9A-9B, thereby showing the displacement from initial to final. In images of FIGS. 9E-9F, note the palatal cortex is partially violated in the mid palatal area. This region has been shown to remodel. Also, note there is no perforation on the labial aspect of the alveolar process. FIGS. 9F-9H show images with a similar amount of retraction of the incisal edge with root movement being simulated. Note, the extensive perforation in the apical part of the root on the palatal in the image of FIG. 9J as compared to initial image in FIG. 9I. It is well known that the apical part of the palatal cortex is resistant to modeling and perforations in this area tend to be permanent.

FIGS. 10A-10B show image example of soft tissue constraint. Soft tissue gingival simulation is performed. Gingiva to tooth movement ratio set at 1:1. FIG. 10A shows initial tooth model, whereas FIG. 10B shows that gingival level has moved occlusally at the same level of the tooth.

FIGS. 11A-11D show image examples of root constraint. Note the neighboring tooth collision can cause root resorption.

FIGS. 12A-12B show image examples of anatomical constraint. Maxillary sinus can cause another biological constraint. Note the sinus has remodeled in the image of FIGS. 12B.

FIGS. 13A-13B show image examples of root constraint. Note the root collision which can cause a biological constraint and needs to be corrected. FIG. 13C shows that root dilaceration can measured manually or automatically at any level.

FIGS. 14A-14B show block diagrams of the treatment planning procedure disclosed in embodiment of the invention.

FIGS. 15A-15N show images for evaluation of morphology. FIGS. 15A-15D show images of initial models. In the image shown in FIG. 15B, note the initial crowding in lower arch. FIG. 15C shows image of the lower left canine substantially in the bone. In the image shown in FIG. 15D, note lower left canine out of bone. FIGS. 15E-15F show mandibular alveolar bone shape analysis in canine area cross section of the image in FIG. 15E. Mandibular left bone appears thicker in the image in FIG. 15F. Mandibular right bone appears thinner in the image of FIG. 15D. Note lower left canine out of bone. FIGS. 15G-15J show images of bone shape evaluation at different levels (frontal view). FIG. 15G shows 3 mm below CEJ level. FIG. 15H shows Occlusal view 2 mm below CEJ level. FIG. 15I shows Occlusal view 8 mm below CEJ level. FIG. 15J shows comparison of bone shape against symmetrical object to evaluate asymmetry in shape, FIGS. 15K-15N show images for evaluating position of lower left canine in bone (sagittal view). FIG. 15M shows normative size tooth from database evaluation against patient. Note that the patient tooth is much larger and out of bone. Diagnosis is that canine is out of bone because the tooth size is large and the bone is thin. FIG. 15N shows normative tooth size compared to patient's lower left canine (occlusal view).

FIGS. 16A-16D show images for risk evaluation. FIG. 16A shows initial (pretreatment) image. Note that lower incisors in bone and crowding. FIGS. 16B-16C show lower arch treatment, original (blue) compared to final (white). Note the position of lower incisors pulled out of bone after treatment (C). FIG. 16D shows sagittal view showing the effect of treatment (teeth pulled out of bone).

FIGS. 17A-17C show simulation images showing changing nature of tooth movement and evaluating bone tooth movement response. Bone tooth (BT) movement ratio applied 0.2:1, FIG. 17A shows simulation visualized from frontal view. Note incisor out of bone. FIG. 17B shows center of rotation at root apex. FIG. 17C shows center of rotation at incisal edge. Note extreme buccal bone perforation.

FIGS. 18A-18C show simulation images of lower incisor extraction with Bone tooth (BT) movement ratio applied 1:1. Note that no bone loss (FIG. 18A) and teeth maintained in bone and crowding resolved (FIGS. 18B-18C). FIG. 18A shows frontal view. FIG. 18C shows comparison of lower incisor crowding, initial (blue) and simulation (white).

FIGS. 19A-19C show images for predicted prognostic simulation similar to actual outcome. FIG. 19A shows frontal view. Note the teeth out of bone. FIG. 19B shows crowding resolved. Predicted prognostic simulation based upon patient evaluation (risk factors) and normative database. FIG. 19C shows tooth movement type in relationship to appliance and risk profile index. Note the anticipated center of rotation at apex of root. B:T ratio predicted is 0.4:1.

FIGS. 20A-20C show images without roots or bone data used in this simulation. FIG. 20A shows that one cannot evaluate root bone relationship with simulation if root and bone data is not available. FIG. 20B shows unability to determine risk of root proximity to bone. FIG. 20C shows crowding resolved, but, it is impossible to evaluate the position of roots with respect to bone.

FIGS. 21A-21C show images of only root data used in this simulation. FIG. 21A shows that one can only evaluate root to root relationship and not to bone. FIG. 21B shows that it is not possible to evaluate bone response or relative position of root to bone. FIG. 21C shows that it is impossible to evaluate bone and soft tissue response.

### DETAILED DESCRIPTION OF PREFERRED EMBODIMENT

Orthodontic tooth movement (OTM) is a result of two interrelated events 1) bending of alveolar bone and 2) remodeling of the periodontal tissues. These events are triggered through the application of mechanical forces to the tooth. Disregard of the interaction between the applied orthodontic forces, the type of tooth movement and the anatomical constraints may lead to unfavorable sequel such as bone loss, gingival recession or root resorption. Therefore, an understanding of the nature of the interaction between these factors and their influence on the biological response is vital to ensure predictable and stable treatment outcomes.

The present invention has 3 main components: Diagnostic, Prognostic and therapeutic using visualization, simulation, and 3D images.

Diagnostic: Nature of anomaly compared against internal control as well as normative data base.

Measures include shape and size volume of maxillary and mandibular alveolar processes. Quality of bone. Thickness of cortical bone and extent. Same for soft tissue and tooth measures crown root. All this at any level of the craniofacial skeleton. Size matching at any level to understand nature of the problem. Mechanical data can be added eg youngs modulus, genotype or history of response etc Phenotype, biotype, genotype plot reponse to stress field Registery

Simulations driven by nature of tooth movement, region, and anticipated response based upon published studies or monitoring patient response at soft tissue, dental, bony level.

Expect 1:1 displacement doesn't occur. Reality displacement ratio maybe 1:0.8. Simulate modeling and remodeling change ie shape. Also shape change driven by direction, type of movement, region, amount of movement, speed of movement.simlate time dependant rate of modeling and other risk factors such as alveolar bone morphology

Sliders to set limits in software plus visualization tools

Changes can override interactively or limits can be set by operator based upon clinical monitoring of patient

Physical constraints also modeled.

Eg palatal wall of maxilla doesn't respond to forces so can change resistance locally, while in less dense bone less resistance

Can define any crot for tooth movement or bone or soft tissue

Can model high risk for recession or bone defect or root resorption. Risk analysis can be done automatically.

Therapeutic appliance approach designed to condition and respond to the patient's needs.

### GENERAL DESCRIPTION

A unified workstation environment and computer system for diagnosis, treatment planning and delivery of therapeutics, especially adapted for treatment of craniofacial structures, is described below. In one possible example, the system is particularly useful in diagnosis and planning treatment of an orthodontic patient. Persons skilled in the art will understand that the invention, in its broader aspects, is applicable to other craniofacial disorders or conditions requiring surgery, prosthodontic treatment, restorative treatment, etc.

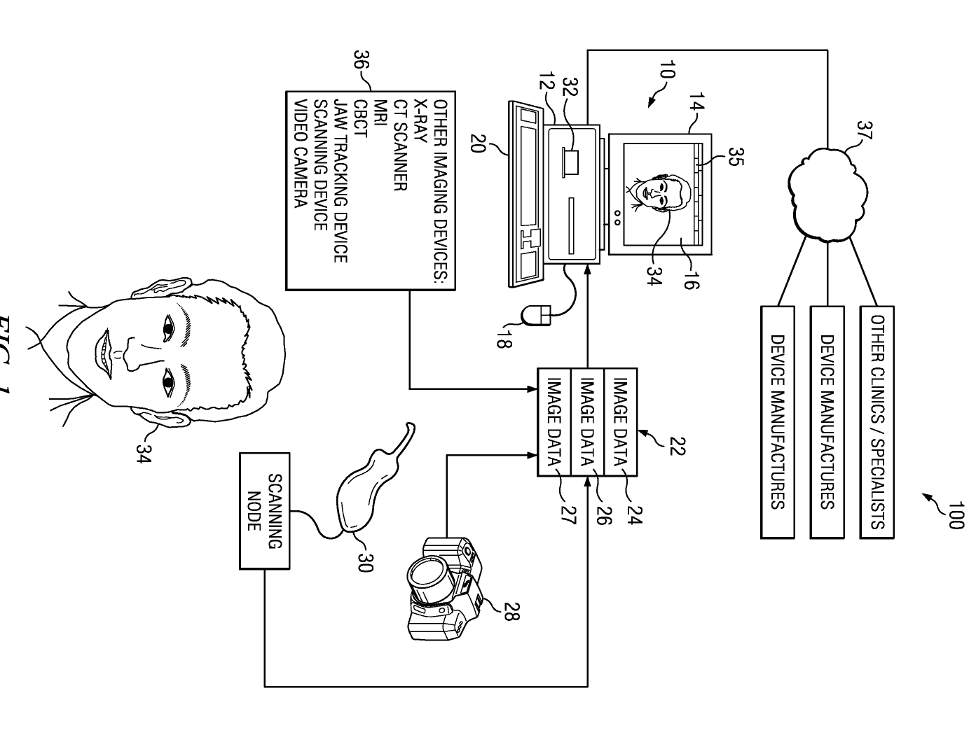

A presently preferred embodiment is depicted in FIG. 1. The overall system 100 includes a general-purpose computer system 10 having a processor (CPU 12) and a user interface 14, including screen display 16, mouse 18 and keyboard 20. The system is useful for planning treatment for a patient 34.

The system 100 includes a computer storage medium or memory 22 accessible to the general-purpose computer system 10. The memory 22, such as a hard disk memory or attached peripheral devices, stores two or more sets of digital data representing patient craniofacial image information. These sets include at least a first set of digital data 24 representing patient craniofacial image information obtained from a first imaging device and a second set of digital data 26 representing patient craniofacial image information obtained from a second image device different from the first image device. The first and second sets of data represent, at least in part, common craniofacial anatomical structures of the patient. At least one of the first and second sets of digital data normally would include data representing the external visual appearance or surface configuration of the face of the patient.

In a representative and non-limiting example of the data sets, the first data set 24 could be a set of two dimensional color photographs of the face and head of the patient obtained via a color digital camera 28, and the second data set is three-dimensional image information of the patient's teeth, acquired via a suitable scanner 30, such as a hand-held optical 3D scanner, or other type of scanner. The memory 22 may also store other sets 27 of digital image data, including digitized X-rays, MRI or ultrasound images, CT scanner, CBCT scanner, jaw tracking device, scanning device, video camera, etc., from other imaging devices 36. The other imaging devices need not be located at the location or site of the workstation system 100. Rather, the imaging of the patient 34 with one or other imaging devices 36 could be performed in a remotely located clinic or hospital, in which case the image data is obtained by the workstation 100 over the Internet 37 or some other communications medium, and stored in the memory 22.

The system 100 further includes a set of computer instructions stored on a machine-readable storage medium. The instructions may be stored in the memory 22 accessible to the general-purpose computer system 10. The machine-readable medium storing the instructions may alternatively be a hard disk memory 32 for the computer system 10, external memory devices, or may be resident on a file server on a network connected to the computer system, the details of which are not important. The set of instructions, described in more detail below, comprise instructions for causing the general computer system 10 to perform several functions related to the generation and use of the virtual patient model in diagnostics, therapeutics and treatment planning.

These functions include a function of automatically, and/or with the aid of operator interaction via the user interface 14, superimposing the first set 24 of digital data and the second set 26 of digital data so as to provide a composite, combined digital representation of the craniofacial anatomical structures in a common coordinate system. This composite, combined digital representation is referred to herein occasionally as the “virtual patient model,” shown on the display 16 of FIG. 1 as a digital model of the patient 34. Preferably, one of the sets 24, 26 of data includes photographic image data of the patient's face, teeth and head, obtained with the color digital camera 28. The other set of data could be intra-oral 3D scan data obtained from the hand-held scanner 30, CT scan data, X-Ray data, MRI, etc. In the example of FIG. 1, the hand-held scanner 30 acquires a series of images containing 3D information and this information is used to generate a 3D model in the scanning node 31, in accordance with the teachings of the published PCT application of OraMetrix, PCT publication no. WO 01/80761, the content of which is incorporated by reference herein. Additional data sets are possible, and may be preferred in most embodiments. For example the virtual patient model could be created by a superposition of the following data sets: intra-oral scan of the patient's teeth, gums, and associated tissues, X-Ray, CT scan, intra-oral color photographs of the teeth to add true color (texture) to the 3D teeth models, and color photographs of the face, that are combined in the computer to form a 3D morphable face model. These data sets are superimposed with each other, with appropriate scaling as necessary to place them in registry with each other and at the same scale. The resulting representation can be stored as a 3D point cloud representing not only the surface on the patient but also interior structures, such as tooth roots, bone, and other structures. In one possible embodiment, the hand-held in-vivo scanning device is used which also incorporates a color CCD camera to capture either individual images or video.

The software instructions further includes a set of functions or routines that cause the user interface 16 to display the composite, combined digital three-dimensional representation of craniofacial anatomical structures to a user of the system. In a representative embodiment, computer-aided design (CAD)-type software tools are used to display the model to the user and provide the user with tools for viewing and studying the model. Preferably, the model is cable of being viewed in any orientation. Tools are provided for showing slices or sections through the model at arbitrary, user defined planes. Alternatively, the composite digital representation may be printed out on a printer or otherwise provided to the user in a visual form.

The software instructions further include instructions that, when executed, provide the user with tools on the user interface 14 for visually studying, on the user interface, the interaction of the craniofacial anatomical structures and their relationship to the external, visual appearance of the patient. For example, the tools include tools for simulating changes in the anatomical position or shape of the craniofacial anatomical structures, e.g., teeth, jaw, bone or soft tissue structure, and their effect on the external, visual appearance of the patient. The preferred aspects of the software tools include tools for manipulating various parameters such as the age of the patient; the position, orientation, color and texture of the teeth; reflectivity and ambient conditions of light and its effect on visual appearance. The elements of the craniofacial and dental complex can be analyzed quickly in either static format (i.e., no movement of the anatomical structures relative to each other) or in an dynamic format (i.e., during movement of anatomical structures relative to each other, such as chewing, occlusion, growth, etc.). To facilitate such modeling and simulations, teeth may be modeled as independent, individually moveable 3 dimensional virtual objects, using the techniques described in the above-referenced OraMetrix published PCT application, WO 01/80761.

The workstation environment provided by this invention provides a powerful system and for purposes of diagnosis, treatment planning and delivery of therapeutics. For example, the effect of jaw and skull movement on the patient's face and smile can be studied. Similarly, the model can be manipulated to arrive at the patient's desired feature and smile. From this model, and more particularly, from the location and position of individual anatomical structures (e.g., individual tooth positions and orientation, shape of arch and position of upper and lower arches relative to each other), it is possible to automatically back solve for or derive the jaw, tooth, bone and/or soft tissue corrections that must be applied to the patient's initial, pre-treatment position to provide the desired result. This leads directly to a patient treatment plan.

These simulation tools, in a preferred embodiment, comprise user-friendly and intuitive icons 35 that are activated by a mouse or keyboard on the user interface of the computer system 10. When these icons are activated, the software instruction provide pop-up, menu, or other types screens that enable a user to navigate through particular tasks to highlight and select individual anatomical features, change their positions relative to other structures, and simulate movement of the jaws (chewing or occlusion). Examples of the types of navigational tools, icons and treatment planning tools for a computer user interface that may be useful in this process and provide a point of departure for further types of displays useful in this invention are described in the patent application of Rudger Rubbert et al., Ser. No. 09/835,039 filed Apr. 13, 2001, now issued as U.S. Pat. No. 6,648,640, the contents of which are incorporated by reference herein.

The virtual patient model, or some portion thereof, such as data describing a three-dimensional model of the teeth in initial and target or treatment positions, is useful information for generating customized orthodontic appliances for treatment of the patient. The position of the teeth in the initial and desired positions can be used to generate a set of customized brackets, and customized flat planar archwire, and customized bracket placement jigs, as described in the above-referenced Andreiko et al. patents. Alternatively, the initial and final tooth positions can be used to derive data sets representing intermediate tooth positions, which are used to fabricate transparent aligning shells for moving teeth to the final position, as described in the above-referenced Chisti et al. patents. The data can also be used to place brackets and design a customized archwire as described in the previously cited application Ser. No. 09/835,039.

To facilitate sharing of the virtual patient model among specialists and device manufacturers, the system 100 includes software routines and appropriate hardware devices for transmitting the virtual patient model or some subset thereof over a computer network. The system's software instructions are preferably integrated with a patient management program having a scheduling feature for scheduling appointments for the patient. The patient management program provides a flexible scheduling of patient appointments based on progress of treatment of the craniofacial anatomical structures. The progress of treatment can be quantified. The progress of treatment can be monitored by periodically obtaining updated three-dimensional information regarding the progress of treatment of the craniofacial features of the patient, such as by obtaining updated scans of the patient and comparison of the resulting 3D model with the original 3D model of the patient prior to initiation of treatment.

Thus, it is contemplated that system described herein provides a set of tools and data acquisition and processing subsystems that together provides a flexible, open platform or portal to a variety of possible therapies and treatment modalities, depending on the preference of the patient and the practitioner. For example, a practitioner viewing the model and using the treatment planning tools may determine that a patient may benefit from a combination of customized orthodontic brackets and wires and removable aligning devices. Data from the virtual patient models is provided to diverse manufacturers for coordinated preparation of customized appliances. Moreover, the virtual patient model and powerful tools described herein provide a means by which the complete picture of the patient can be shared with other specialists (e.g., dentists, maxilla-facial or oral surgeons, cosmetic surgeons, other orthodontists) greatly enhancing the ability of diverse specialists to coordinate and apply a diverse range of treatments to achieve a desired outcome for the patient. In particular, the overlay or superposition of a variety of image information, including 2D X-Ray, 3D teeth image data, photographic data, CT scan data, and other data, and the ability to toggle back and forth between these views and simulate changes in position or shape of craniofacial structures, and the ability to share this virtual patient model across existing computer networks to other specialists and device manufacturers, allows the entire treatment of the patient to be simulated and modeled in a computer. Furthermore, the expected results can be displayed beforehand to the patient and changes made depending on the patient input.

With the above general description in mind, additional details of presently preferred components and aspects of the inventive system and the software modules providing the functions referenced above will be described next.

Alveolar Process Morphology and Characteristics Associated with Facial Type

The boundaries of the maxillary and mandibular alveolar process and the cortical plates impose limitations on OTM. An understanding of the normal morphology and factors that influence the shape and size of the alveolar processes is important in planning for OTM.

Published research has shown that:
(a) Patient's age, ethnicity, morphotype, functional status and periodontal status can all affect the shape and size of the alveolar process.
(b) Maxillary and mandibular buccolingual bone width generally increases from the anterior towards the posterior and from the cervical margin to the root apex cervical line to the root apex. In other words, bone tends to be thicker closer to the cervical margin as one moves from the anterior teeth to the posterior teeth.
(c) The maxillary buccolingual width is normally wider than the mandibular.
(d) The mandibular alveolar trough sets the limits for expansion of the maxillary arch.
(e) With regards to cortical bone thickness, maxillary buccal cortical bone is on average about 1 mm or so thick and shows little variation in this dimension from the cervical line to the root apex. The palatal cortex bone is also about 1 mm thick and it may increase in thickness by about 0.5 mm towards the apex.
(f) During torqueing movements there is a high possibility for the root apex to initially collide with the palatal cortex and cause a fenestration.
(g) Mandibular cortical bone thickness in the anterior region is generally about 1 mm in thickness at the cervical margin, and progressively increases to about 3 mm in thickness as one approaches the second molar region. Cortical thickness has a tendency to increase as one moves apically.
(h) The mandibular palatal cortical bone width has about the same thickness as the labial for the anterior teeth, but is much thicker (2-2.5 mm) than the buccal for the mandibular canine to second bicuspid region. Typically, the buccal cortical wall thickness in the first molar and second molar region tends to be thicker than the palatal.
(i) The morphology of the alveolar process is related to the facial type. In general, the mandible has the thickest cortical bone in its base, with greatest thickness below the lateral incisors and canines. The buccal bone is thicker in the posterior region around the molars. The lingual bone is more even in thickness, except for the lower lingual region at the symphysis, which is where the lingual bone is thickest.
(j) In general, a long-face individual has thinner cortical bone especially in the incisor region. In contrast, a short-face individual has thicker cortical plates in almost all regions of the buccal and lingual areas of the mandible. The smaller the gonial and mandibular plane angles, the thicker the buccal cortical bone. This applies to the upper buccal cortical bone, especially around the premolar and canine regions. The cortical bone thickness decreases in almost all sites for every one degree change in the SN-MP plane angle (0.002-0.031 mm/degree). Up to the age of 50, the cortical bone thickness increases (0.01-0.26 mm/10 years), after which it decreases. No differences in cortical bone thickness were seen between the sexes.
(k) For all facial types the height of cross-section through the mandible is the shortest in the molar region and rapidly increases at the region of the first premolars. The long-face individual has the shortest height of the mandibular cross-section at the molars with the longest cross-sectional height from canine to canine. The short-face individual shows the least change in height from the molars to the symphysis. Cortical bone mineralization varies with vertical facial dimension.
(l) The relationship between the morphology of the alveolar process of the mandibular symphysis with the three facial types, namely: hypodivergent, normodivergent and hyperdivergent. For all facial types, both the labial and lingual cortical plates appear to have about the same thickness at the level of cervical and middle thirds of the roots. The hypodivergent as opposed to the hyperdivergent face has the thickest alveolar ridge and facial and lingual cortical plates which reside at the level of the apical third of the root. The root apices for the hypodivergent face tend to be further away from the buccal and lingual plates, thus allowing for greater freedom of root movement. Subjects with increased, mandibular plane angles (44.2±5) and Class III occlusions have a thin alveolus around the mandibular incisors. In Class II patients with steep mandibular plane angles, a thin alveolus is found around the maxillary incisor apex. Also, patients with increased lower facial height have thin alveolar bone. The incisors, as they erupt, establish overbite in patients with long faces.
(m) The width of the symphyseal region is similar in adult Class III crossbite and normal occlusion groups, but, significantly narrower in the adult Class III openbite group.
(n) The labiolingual inclination of the mandibular incisors has been shown to be related closely with the labiolingual inclination of the mandibular alveolar bone on both the labial and lingual side.
(o) Facial type is significantly correlated with both alveolar bone thickness and the distance between the root apex and palatal cortex in the anterior maxillary alveolar process. At the level of the root apices, short-face patients generally show greater bone thickness than long-face patients, while the normal-face patients have intermediate bone thickness.
(p) For all three facial types, there are no differences in alveolar bone thickness for the lateral incisors, and no differences in alveolar height measures for the four anteriors or their inclinations.

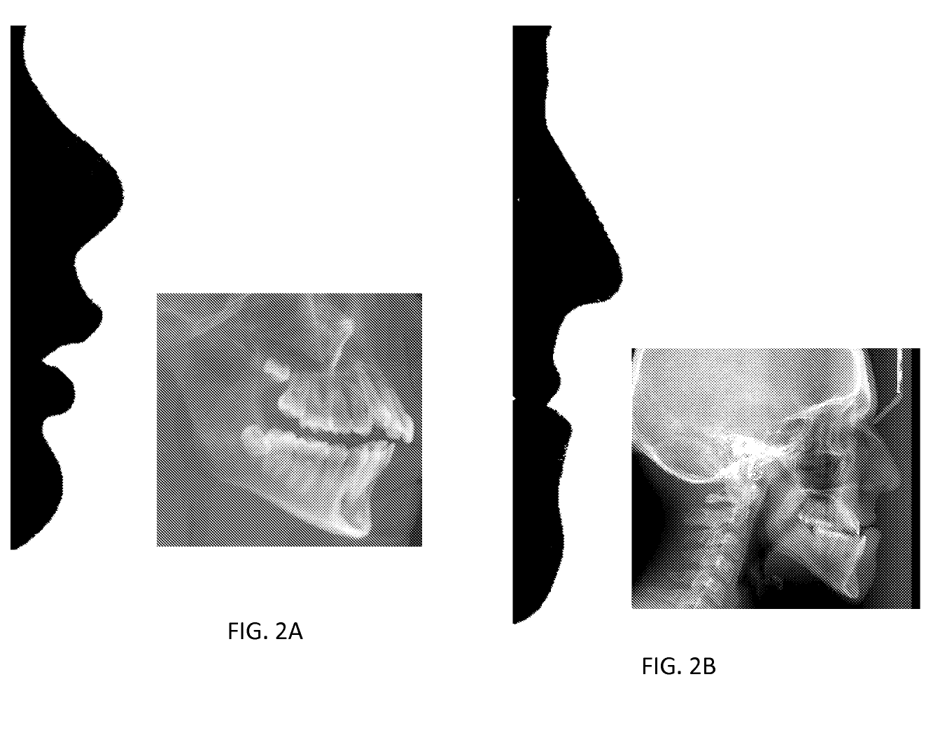

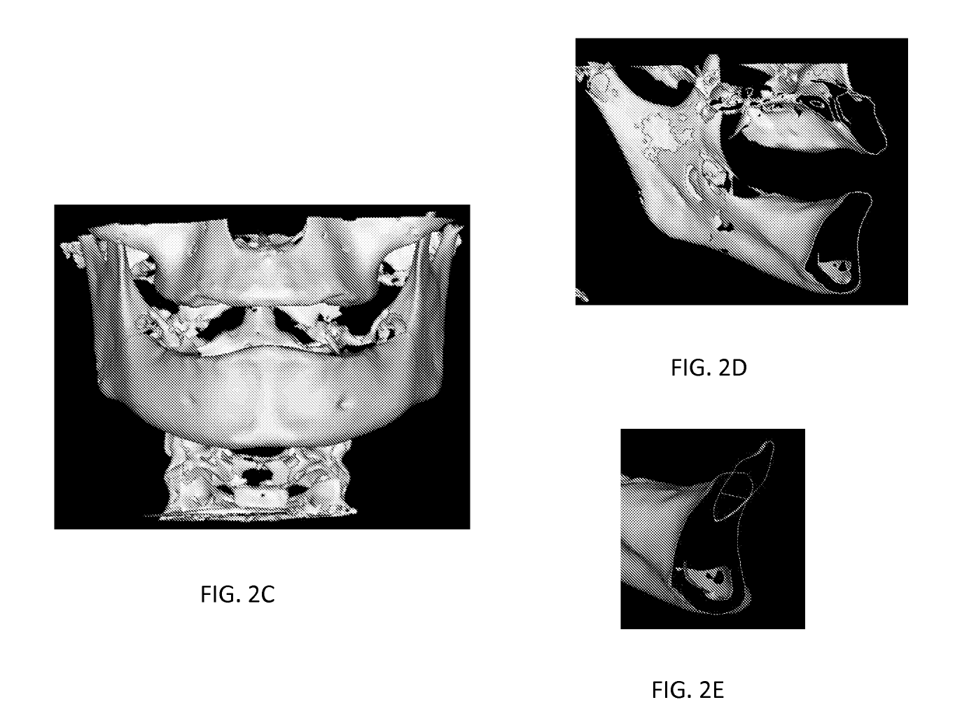

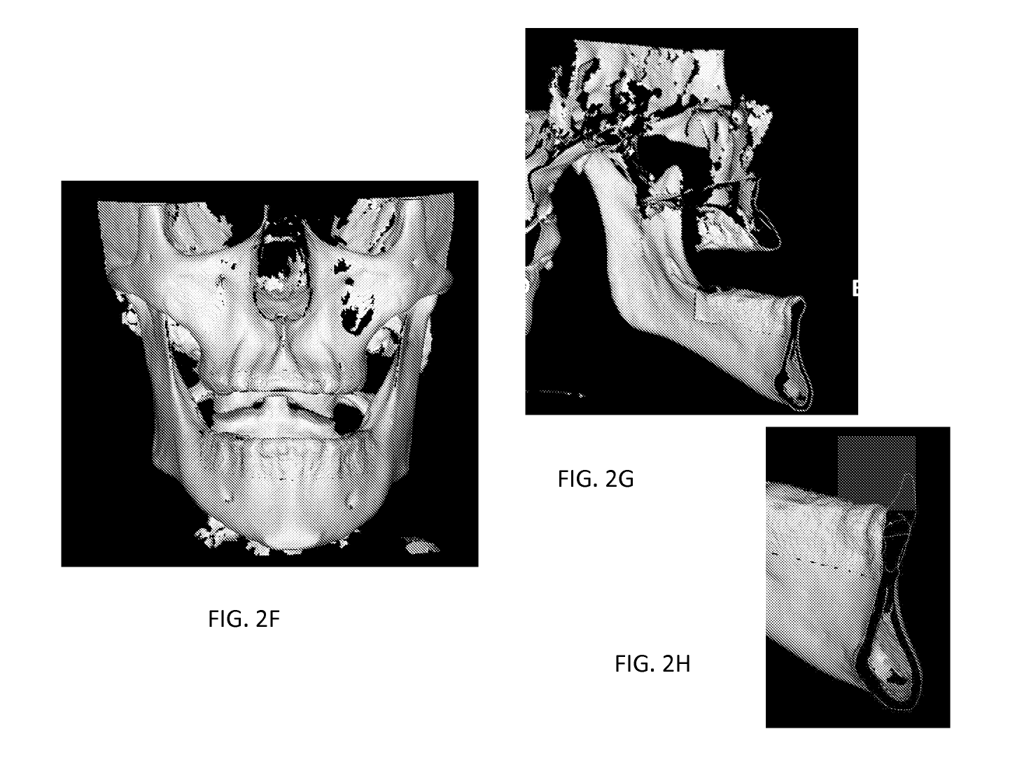

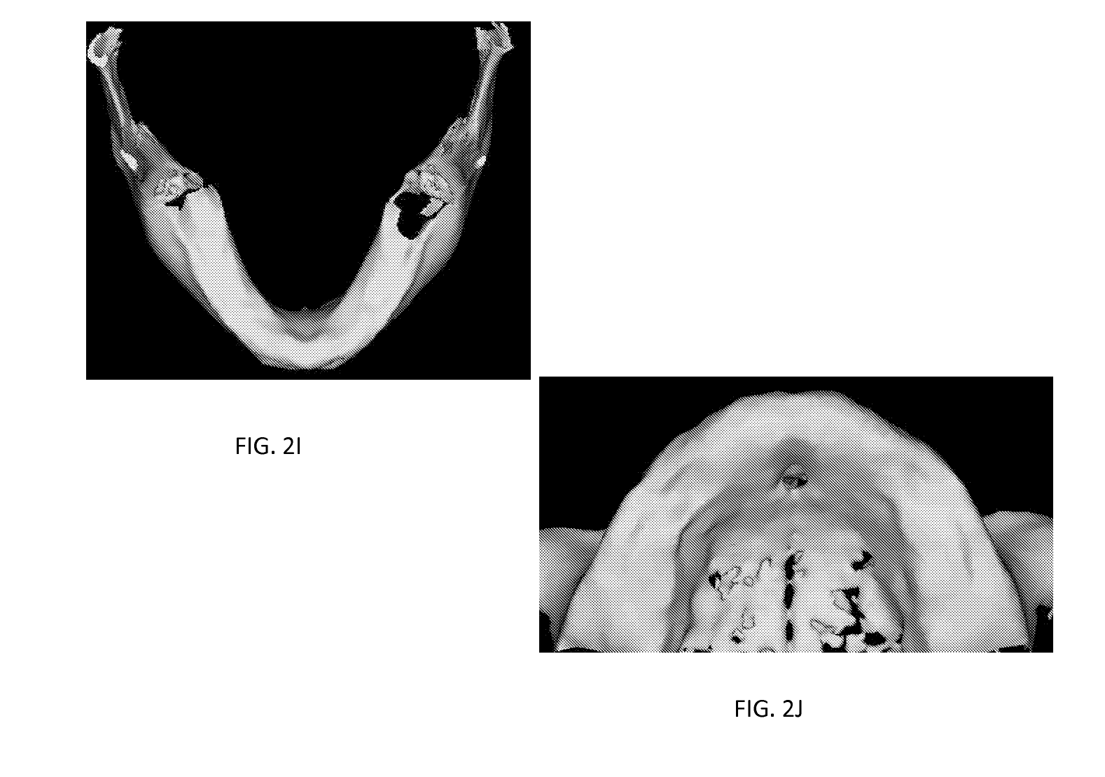

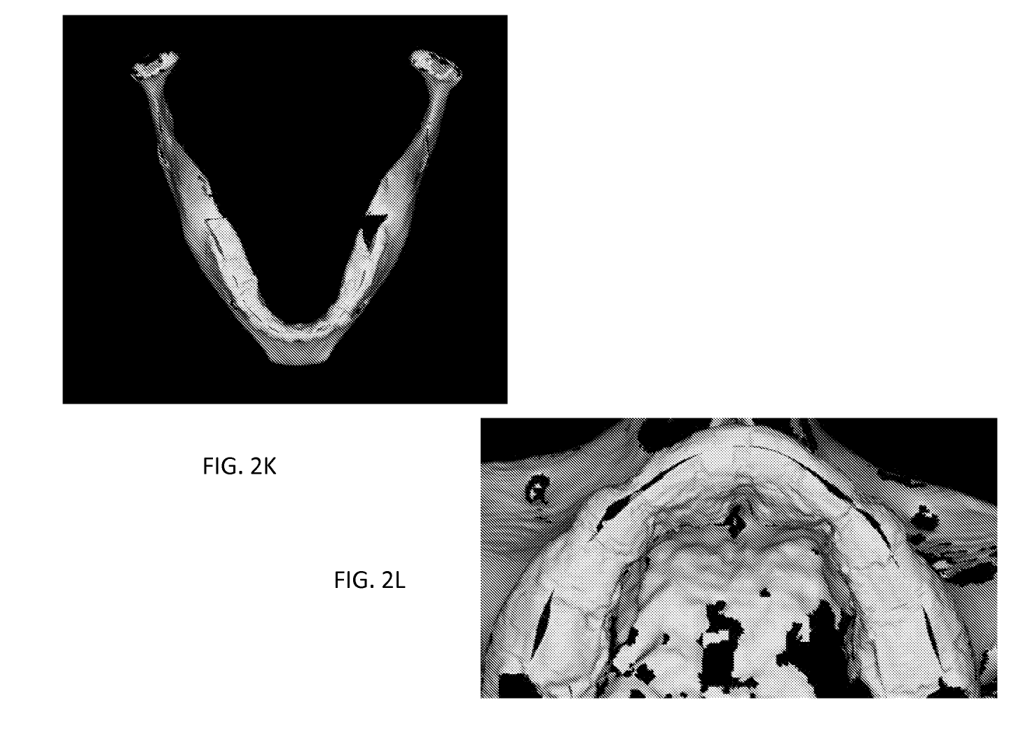

FIGS. 2A and 2B show two different patients, one with short facial height (Hypodivergent), and another with long facial height (Hyperdivergent), respectively.

FIGS. 2C-2E show a Hypodivergent patient's facial skeleton; with FIG. 2C showing the front facial view, FIG. 2D showing a lateral view and FIG. 2D showing a segital cross-sectional view.

FIGS. 2F-2H, similarly, show a Hyperdivergent patient's facial skeleton; with FIG. 2F showing the front facial view, FIG. 2G showing a lateral view and FIG. 2H showing a segital cross-sectional view.

Note the differences in both width and height of the alveolar processes between the two facial types.

FIGS. 2I-2J show another view of a Hypodivergent patient's facial skeleton, with FIG. 2I showing a mandibular or lower occlusal view, and FIG. 2J showing a maxilla or upper occlusal view.

FIGS. 2K-2L, similarly, show another view of a Hyperdivergent patient's facial skeleton, with FIG. 2K showing a mandibular or lower occlusal view, and FIG. 2L showing a maxilla or upper occlusal view.

Note the differences between the width of the alveolar troughs in the two facial types.

Bone Defects

Dehiscences and fenestrations are two types of bone defects commonly seen in the maxilla and mandible of non-orthodontically treated patients. They are often considered non-pathological and a normal variation of the periodontal architecture.

A. Dehiscence

A dehiscence is a defect of the alveolar radicular bone and is a result of the lowering of the crestal bone margin leading to the exposure of the root surface with absence of cortical bone coverage. Dehiscence has also been described as a defect where the crest of the radicular bone is at least 4 mm apical to the crest of the interproximal bone, as measured from the cementoenamel junction. Obviously, this definition is limited. Any diminution in height of the interproximal bone can affect this measure. The presence of dehiscence is positively correlated with thin alveolar bone. In the published literature, multiple factors have been associated with the development of dehiscence; namely, ectopically positioned teeth, frenum attachment, patient habits, traumatic occlusion, iatrogenic, normal aging, traumatic tooth brushing and inflammation. The radicular alveolar bone around the mandibular canines appears to be most prone to these defects, followed by the mandibular first premolars and maxillary canines. These findings have a number of clinical implications. They suggest that a clinician may underestimate bone loss around a tooth affected by recession. It should also be noted that tooth mobility is not a good indicator of bone loss. Unawareness of the presence and extent of bone loss may lead to unpredictable tooth movement. Also, if not detected in advance, such defects can complicate periodontal surgery and implant placement by affecting both the procedure and healing process.

B. Fenestration

Another type of bone defect commonly seen is a fenestration. This defect of the alveolar radicular bone is well circumscribed with the underlying root being exposed and covered by periosteum and gingiva. However, the alveolar bone margin remains unaffected. Many etiological factors have been associated with the development of fenestrations; namely, prominent root with thin alveolar bone, more deviation from normal bucco-lingual inclination of tooth, discrepancy between tooth/bone ratio and significant relationship with periodontal disease. Since fenestrations are more commonly located in the apical half of the root and can also be found lingually, the orthodontist needs to be cautious about both torquing movements and uncontrolled tipping both of which may lead to the roots being further exposed, as they may be pushed out of these defects. Again, these defects can complicate periodontal surgery and implant placement. To summarize, the early detection of both alveolar bone dehiscence and fenestration can allow for better planning of OTM and possibly prevent future complications.

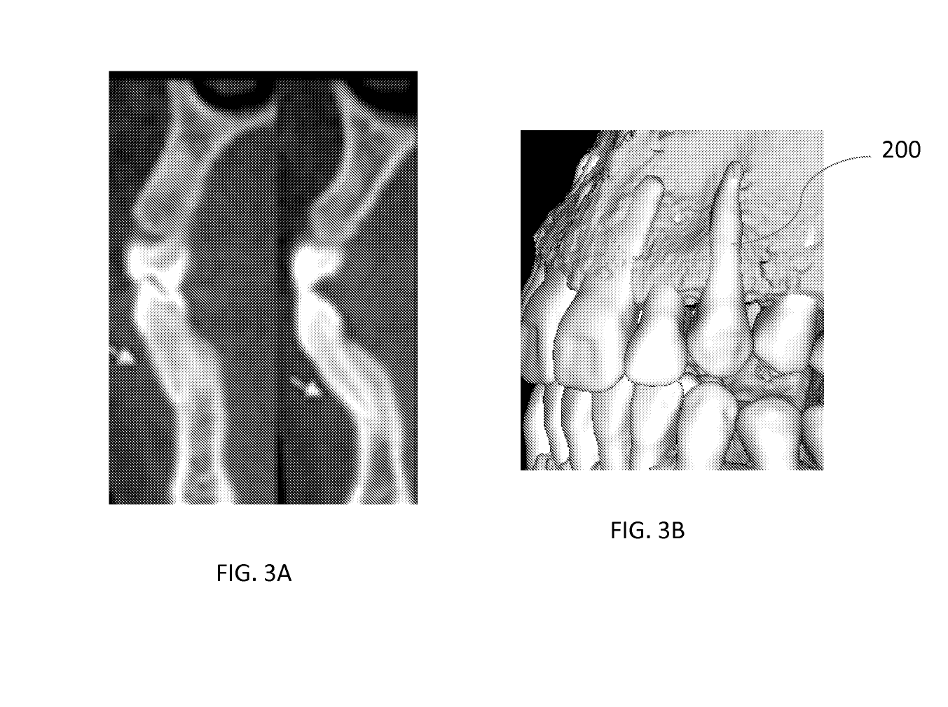

FIG. 3A shows Dehiscence viewed on CBCT; whereas FIG. 3B shows Dehiscence viewed on a CBCT surface volume rendered image with root 200 outside of the bone.

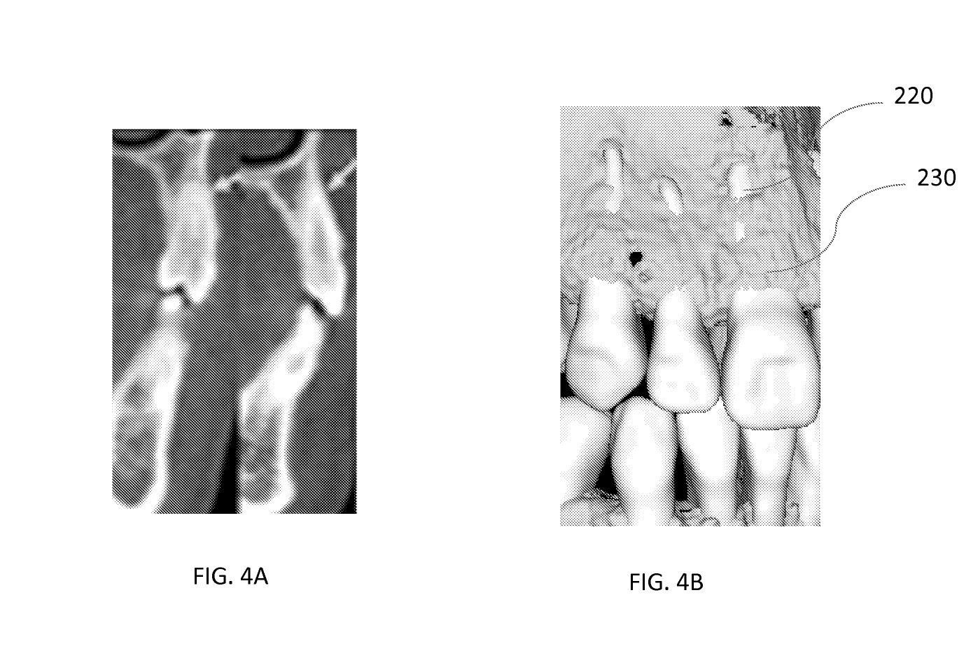

FIG. 4A shows Fenestration viewed on CBCT; whereas FIG. 4B shows Fenestration viewed on a CBCT surface volume rendered image with root 220 outside of the bone 230.

Reaction of Periodontium to OTM

A. Dehiscence and Labial Movement of Incisors

Many orthodontic treatment philosophies are based upon defining the antero-posterior position (A-P) of the lower incisor in determining and managing arch length discrepancy and achieving a stable result. More often than not, anterior crowding is commonly resolved by advancing the lower incisors or, at the other extreme, by extraction accompanied with maximum retraction of the lower incisors. An understanding of the limits and response of the periodontium to the sagittal movement of the incisors is warranted in order to establish a biological basis for planning incisor movement. Maintaining the incisors in forward position over time has not been shown to aid in recovery of the lost bone height. Studies have been published showing that a reversal in the direction of incisor movement towards the initial position, led to repair of the iatrogenically induced bone defects with no loss of attachment, providing inflammation was well controlled. In summary, tipping or translating of incisors labially is associated with loss of marginal bone height, which creates bone dehiscence. Furthermore, patients with skeletal Class III malocclusion generally have narrow alveolar process in the mandibular symphysis region and be at greater risk of developing dehiscence in the lower incisor area as a result of OTM. Bone dehiscence as a result of labial proclination may recover by reestablishing the original position of the incisor.

Mucogingival Recession

A. Prevalence and Etiology

Gingival recession is the displacement of the gingival margin apically to the cementoenamel junction. There is no consensus on the incidence of gingival recession in the untreated population. Prevalence of recession increases with age. Prevalence of gingival recession has also been shown to be gender and population dependent. The most commonly affected sites are the labial surfaces of the mandibular central incisors and buccal surfaces of the maxillary molars and the maxillary canine and premolars. Multiple factors have been associated with the etiology of gingival recession. Plaque is considered a factor in precipitating gingival recession. There appears to be a relationship between the position and inclination of the lower incisors and the width of keratinized gingiva. Proclined incisors have less keratinized gingiva. When a proclined incisor is retracted it is accompanied with an increase in the width of keratinized gingiva. Additionally, bone dehiscence also has been associated with recession.

B. Mucogingival Recession and OTM

Orthodontic treatment has been associated with the development of mucogingival defects as well. Labial movement of mandibular incisors has been considered to be a risk factor for gingival recession. In other words, for patients at risk gingival recession may manifest itself post orthodontic treatment. It has been reported that there is an association between thinning of the gingiva and the labial movement of the incisors with the consequence of gingival recession. There is an increased risk of recession developing when a tooth is moved out of its alveolar bone housing and bone dehiscence has been created. In humans, the prevalence of gingival recession in response to orthodontic treatment appears to be very low. A number of risk factors associated with gingival recession have been identified in published literature. These included: preexisting gingival recession, gingival biotype, width of keratinized gingiva and gingival inflammation. The skeletal Class III patient with severely retroclined incisors appears to be at risk of developing mucogingival recession. Current research appears to favor the observation that proclination of the lower incisors in Class II patients with adequate alveolar bone support does not appear to put an individual at risk for developing mucogingival recession. However, Angle Class III patients may have a high predisposition towards developing recession, especially those with minimal alveolar bone support as is seen in skeletal Class III open bite patients. The risk of gingival recession also appears to be linked with the thickness of the labial marginal gingival tissue (gingival biotype) rather than its width or the amount of keratinized gingiva.

C. Transverse Movement

Transverse expansion of the maxilla has been implicated as a risk factor in promoting dehiscence. According to published studies, patients with thin buccal cortical bone are more prone to dehiscence; and gingival recession did not occur immediately post RME, but, did manifest itself over time. The results of published studies suggests that low-force archwires in combination with self-ligating brackets (passive or active) do not provide controlled tooth movement in either arch and more importantly can lead to considerable buccal alveolar bone height loss, which does not appear to recover one year post treatment. Also, with this technique, the first premolars appear to be at a higher risk for bone loss since they reside in a narrow alveolar housing and are subject to the greatest expansion.

Space Closure—Reaction of the Periodontium to Retraction of Incisors and Torquing

A. Retraction of Incisors

Palatal or lingual bone dehiscence in the maxilla and mandible appears to be a consistent finding in response to maximum incisor retraction, and in patients with narrow alveolar processes. In addition, clinical or cephalometric examination does not provide a reliable means to identify bone loss. In patients with narrow anterior alveolar processes requiring extraction therapy, one may consider controlled tipping as a viable approach to the retraction of the anteriors. This however may affect the crown inclination adversely and lead to a poor aesthetic result. In such situations, one maybe compelled to partially close the space and consider one or more of the following strategies to manage the residual space: selectively rotating some of the teeth to occupy more space, tipping the teeth adjacent to the extraction site, building up teeth with minimal invasive restorations or leaving space out of the visual field. Also, to minimize the unwanted consequences of significant retraction of the incisors through thin alveolar processes, selective interproximal reduction may be considered in lieu of extractions. Alternatively, for the patient at risk of bone dehiscence, one may consider a segmental surgical approach to space closure after separate canine retraction. This procedure maybe fraught with some risk of periodontal damage at the site of the osteotomy. Any therapeutic solution for space closure in a patient at risk should be targeted specifically to meet with the patient needs and safety.

B. Torquing of Incisors

The anterior alveolus of the maxilla (labialis maxillare) imposes constraints on incisor movement. The limits to sagittal movement of the incisors both in the anterior portion of the maxilla and the symphyseal region of the mandible is imposed by the width of the alveolar process and the thickness of the cortical plate and its biological response to orthodontic forces. This warrants careful planning of care and a first step in assuring a successful outcome requires the Orthodontist to design a Visual treatment objective to define the planned movements within the “Orthodontic Walls”.

C. Tooth Movement and Atrophic Ridges

Loss of alveolar bone or the development of atrophic alveolar ridges commonly occurs subsequent to tooth loss as a result of caries, endodontic pathology, facial trauma, periodontitis, aggressive extraction and areas of congenitally missing teeth. Greater bone resorption is seen on the facial versus the lingual aspect of the alveolar ridge and more in the mandible than the maxilla. Also, width loss tends to be on average about two times greater than height over a period of 12 months. Atrophic alveolar bone ridges generally complicate OTM as teeth need to be moved through dense cortical bone since the trabecular bone has resorbed substantially. Successful OTM can be achieved through knife-edge alveolar ridges without loss of bone. The nature of tooth movement affects the modeling/remodeling response of the atrophic alveolar ridge. Bodily tooth movement encourages frontal bone resorption and promotes a tissue generative response as the tooth moves “with bone” through the denuded ridge. In contrast, tooth movement “through bone” is a result of tipping movement which encourages tissue hyalinization, which in turn triggers undermining bone resorption. Translatory movement of the premolars can be accompanied with little or no damage to the periodontal structures. Successful tooth movement through an edentulous site without loss of its periodontal integrity is possible. This requires translatory mechanics which may not be effectively accomplished by common approaches to space closure such as with sliding mechanics. Also, the necessity to control plaque-induced inflammation during space closure to prevent bone loss cannot be over emphasized. The integrity of the periodontium of teeth adjacent to extraction sites could be maintained if daily mouth rinses of chlorhexidine are recommended immediately post extraction for a period of 30 days.

Implant Placement and Atrophic Ridges

Atrophic bone ridges can also make implant placement challenging. The success of implant placement is dependent upon the adequacy of sufficient hard and soft tissue volumes.¹⁴⁸ Additionally, an atrophic ridge may create an aesthetic problem in the design of an implant-supported restoration. The techniques of alveolar bone development by using forced eruption to regenerate bone volume can be used. This procedure has been successfully applied to increase bone volume to facilitate the placement of an implant within the thickness of the bone with a suitable axis. Furthermore, added bone volume by extrusion has been shown to optimize the potential of guided bone regeneration technique. However, it is important to recognize that as a tooth is extruded the volume of bone generated around the root is reduced because of its tapered structure. This leads to a concavity in the buccal surface which makes it difficult to manage the soft tissue and match a restoration with the unaffected contralateral side. To counteract this loss of bone, the application of labial root torque with extrusion to increase the buccolingual width of bone. It should be noted that labial root torque has a tendency to diminish the effectiveness of the extrusive force. In situations where the upper incisor is proclined, a large clockwise moment may be generated by the extrusive force encouraging the labial displacement of the root and obviating the necessity of applying labial root torque. Applications of selective mesiodistal tipping forces to affect bone development in the proximal areas may also aid in developing and supporting the papilla. Six months of stabilization post extrusion has been recommended to allow for bone remodeling and the decrease of relapse.

Extrusion and Infrabony Defects

Orthodontic extrusion as a treatment strategy has also been successfully employed in reducing infrabony defects (one or two wall/angular) and reducing isolated periodontal pockets for a single tooth or a group of teeth. Controlled eruption of a tooth augments the bone ridge as well as the quantity of attached gingiva. The prognosis of treating one-wall defects with GTR has been shown to be poor. Also, extrusion has been used to affect crown length, crown to root ratio and gingival esthetics. Continuous extrusive forces no greater than 30 g with a line of action through the center of resistance of the tooth/teeth are recommended. As a tooth is extruded it commonly requires occlusal reduction to eliminate interferences and in some situations may need prosthetic and endodontic treatment as a part of the overall treatment strategy. It has also been suggested that for every 1 mm of intrusion, four weeks of retention should be planned. Also, to avoid the coronal migration of the periodontal attachment some authors recommend weekly fiberotomy of the supracretal gingival fibers.

Molar Uprighting

Many investigators have reported the correction of vertical bone defects associated with mesially tipped molars as a response to uprighting and have observed no loss of attachment with this procedure. As a result of the extrusive forces associated with uprighting molars, the exposure of furcations remains a distinct possibility.

Rotation

Correcting tooth rotations has been shown to result in bone dehiscence and recession. This is probably the result of the exposure of the wider part of the buccal radicular surface as it is corrected within the confines of a narrow alveolar process. Added force systems such as expansion may add to this risk especially in the lower canine, first bicuspid region which is prone to have dehiscences because of thin alveolar bone and the close proximity to the frenum.

Infrabony Defects and Incisor Intrusion

In adult patients with horizontal bone loss and deep bites as a result of progressive periodontal disease, intrusion may be successfully employed to improve or stabilize both the orthodontic and periodontal condition of a patient. However, this requires a disciplined approach to treatment. First, periodontal disease needs to be controlled with periodontal treatment which may require scaling and root planning or periodontal surgery followed by adherence to a strict oral hygiene regimen by the patient. Secondly, a controlled and consistent force system with continuous force levels between 5-15 grams needs to be applied to ensure that the line of action of the intrusive force is directed through the estimated center of resistance of the affected tooth or teeth. Crown length has been reported to shorten between 0.5 mm-1.00 mm in response to intrusion with a gain in attachment of 0.7 to 2.3 mm.

Molar Intrusion

In a study, due to the proximity of roots resulting from intrusion, the inferior alveolar neurovascular bundle appeared to reposition. No iatrogenic damage was seen. The inner surface of the cortical bone remodeled to enlarge the marrow spaces to accommodate this repositioning. In a study it was observed that the buccal sides around the intruded molar roots were rich in woven bone, while the palatal side was rich in lamellar bone. The roots did perforate the sinus but no fistula was observed on the nasal floor lining lifted and a thin layer of newly formed bone covered the intranasal portion of the intruded tooth.

Managing Bone Defects

Bone defects commonly resulting from periodontal disease are classified based upon their topology, extent and location. These bone defects include: interproximal craters, one-two- and three-wall defects, furcation involvement, and horizontal bone loss. Only some of these defects are responsive to orthodontic correction. A brief overview of the published approaches to managing these defects is summarized in Table 1.

TABLE 1
Summary of management of osseous defects.

| OSSEOUS | | | |
|---|---|---|---|
| DEFECT | Define | Location | Treatment |
| Osseous | Most prevalent bone defect | Interdental | Shallow craters maintained non- |
| craters/ | found interdentally with | areas | surgically |
| interdental | facial and lingual walls | | Reshape defect and reducing |
| crater/ | remaining, involves both | | the pocket depth. |
| Two-wall | the interproximal walls. | | Orthodontic treatment does |
| defect | | | not help. |
| One-wall | Defect limited by one | Interdental | Orthodontic treatment ideal |
| | osseous wall and the | areas. | approach as it minimizes or |
| | tooth surface. Formed | Mesial | eliminates defect through |
| | when the mesial or distal | tipped | extrusion |
| | portion of the interdental | molars | Periodontal treatment with |
| | bone septum is reabsorbed, | | Root planning |
| | or likewise the two buccal | | |
| | or lingual cortical laminae. | | |
| Three-wall | Occurs most frequently in | Lingual | Pocket reduction with regenerative |
| | the interdental region, | surfaces of | periodontal therapy¹⁹⁵ |
| | usually the remaining bony | the | Bone grafting, root conditioning and |
| | walls are facial, lingual | maxillary | GTR |
| | and proximal can be | and | Orthodontic treatment recommended |
| | circumferential defects. | mandibular | 3-6 months post surgery (If |
| | | teeth | periodontally stable) |
| Horizontal | Bone loss perpendicular to | | Open flap debridement and root |
| bone | the long axis of the tooth, | | planning. No root planning if |
| | along the whole length of | | pocket loss. Minimal ortho |
| | the alveolar bone crest, | | treatment to maintain flat |
| | with occurrence of | | osseous crest periodontal |
| | reabsorption of the buccal | | surgery if pocket exists. The |
| | and lingual cortical | | outcome of the orthodontic |
| | laminae, including the | | therapy is dependent on the |
| | interdental bone. | | location of the bands and |
| | | | brackets which may be difficult |
| | | | to determine when periodontal |
| | | | defects exists. |
| Grade I | Early lesion with slight bone | | Osseous surgical correction with |
| furcation/ | loss in the furcation area. | | good prognosis |
| Incipient | No x-ray or radiographic | | Lesions can worsen during |
| | findings present. | | orthodontic treatment and need |
| | | | to be maintained at 2-3 months |
| | | | recall schedule. |
| Grade II | Bone destruction is present | | Grafting and regenerative therapy |
| furcation | Partial penetration of probe | | with barrier membrane |
| Moderate/ | into furcation area. X-ray's | | Lesions can worsen during |
| Cul-de-sac | or radiograph may or may | | orthodontic treatment and need |
| | not show changes. | | to be maintained at 2-3 months |
| | | | recall schedule. |
| Grade III | Interradicular bone is | | Gingivectomy or apical reposition flap |
| furcation | completely lost. Defect | | Root resection or root amputation |
| Advanced | is covered by gums | | Hemisection |
| | therefore the furcation | | Bicuspidization |
| | is not visible clinically. | | Lesions can worsen during |
| | Radiograph shows a | | orthodontic treatment and need |
| | radiolucent area between | | to be maintained at 2-3 months |
| | the roots in lower molars. | | recall schedule. |
| Grade IV | Interradicular bone is | | Gingivectomy or apical reposition flap |
| furcation | completely destroyed, | | Root resection or root amputation |
| | gums are receded and | | Hemisection |
| | the furcation of | | Bicuspidization |
| | tooth is clinically | | Lesions can worsen during |
| | visible. | | orthodontic treatment and need |
| | | | to be maintained at 2-3 months |
| | | | recall schedule. |

Response of the Gingiva to Tooth Displacement

Gingiva displaces in the same direction as tooth movement.

Bone Movement to Tooth Movement Ratio

A common axiom in orthodontics is that “bone traces tooth movement” i.e. it remodels at the same rate as tooth movement occurs. If this axiom were true, one might expect a bone remodeling to tooth movement ratio (B/T) of 1:1 for all types of tooth movement. However, current research does not support this. For extrusive movements, the B/T ratio is reported to be 0.8:1. With fiberotomy B/T ratio is 1.6:4.3. With no fiberotomy, it is 2.6:4.3 or 2:3.5. Intrusive movements tend to show a B/T ratio of 1:1. Others have shown tooth movement to exceed bone reduction. In the transverse direction, it has been demonstrated that tooth movement generally exceeds lateral bone remodeling. This has also been found for single tooth movement in the buccolingual direction. In the sagittal plane during space closure, it appears a B/T ratio of 1:1 is maintained providing the movement occurs within the boundaries of the cortical plate. Protraction of maxillary incisors also produces dehiscence of the labial cortical plate and this response is reversible if the tooth returns to its original position. The same restrictions are noted in retraction movements affecting the palatal cortex. It appears that most cortical bone orthodontic induced fenestrations occur when bone has to respond in an apposition mode. In the case of torquing movements, the danger zone is the palatal cortex. It has been suggested that retraction of the root is restricted to 1.5 mm to 2.5 mm since the palatal cortical plate is resistant to structural change. It has been reported that there is the lack of palatal periosteum remodeling with age and therefore the increased risk of fenestration or dehiscence as a result of torque or exaggerated retraction of the root apices in the maxillare labialis. Such fenestrations would take 7-10 years to repair with a possible remission if only roots relapsed anteriorly from the palatal cortex. Since the maxillary anterior roots are generally closer to the labial cortex than the palatal cortex an unfavorable B/T ratio is more apt to predispose the labial cortex to unfavorable sequelae especially in response to protraction or significant uncontrolled forward tipping of the roots of the upper anteriors. It has been reported, based on using laminagraphic, that the development of a thin protective layer of cortical bone subsequent to cortical bone fenestration which is difficult to see using conventional radiography.

Bone Density and Mineralization

According to published reports, one density changes were evaluated using CBCT in patients who were treated non extraction. They observed an average reduction of 24% in bone density around the maxillary incisors 7 months into treatment. Alveolar bone fraction significantly decreased around displaced teeth. Extensive modeling changes in alveolar bone has been reported to have occurred one year post treatment using CT and CBCT imaging respectively. These findings are important because they suggest the remarkable capacity for alveolar bone to model favorably post orthodontic treatment. However, it remains unclear when and for how long such changes continue posttreatment.

Orthodontists need to consider the constraints and response of the biological system to OTM (Orthodontic Tooth Movement) in planning patient care and achieving successful treatment outcomes.

There are limits to OTM. Natural barriers are imposed by the morphology and structure of the alveolar processes. Invasion of these “walls” may result in damage to the periodontium. In some situations this may be corrected if tooth movement is reversed. OTM can also be used creatively to regenerate bone. This generally requires the application of translatory and low continuous forces in an environment which is substantially free of inflammation and where the natural boundaries are not violated.

Presently preferred embodiments of the invention are described below in reference to the appended drawings, wherein like reference numerals refer to like elements in the various views, and in which:

FIG. 1 is block diagram of a system for creating a three-dimensional virtual patient model and for diagnosis and planning treatment of the patient.

FIGS. 2A and 2B show two different patients, one with short facial height (Hypodivergent), and another with long facial height (Hyperdivergent), respectively.

FIGS. 2C-2E show a Hypodivergent patient's facial skeleton; with FIG. 2C showing the front facial view, FIG. 2D showing a lateral view and FIG. 2D showing a segital cross-sectional view.

FIGS. 2F-2H, similarly, show a Hyperdivergent patient's facial skeleton; with FIG. 2F showing the front facial view, FIG. 2G showing a lateral view and FIG. 2H showing a segital cross-sectional view.

FIGS. 2I-2J show another view of a Hypodivergent patient's facial skeleton, with FIG. 2I showing a mandibular or lower occlusal view, and FIG. 2J showing a maxilla or upper occlusal view.

FIGS. 2K-2L, similarly, show another view of a Hyperdivergent patient's facial skeleton, with FIG. 2K showing a mandibular or lower occlusal view, and FIG. 2L showing a maxilla or upper occlusal view.

FIG. 3A shows Dehiscence viewed on CBCT; whereas FIG. 3B shows Dehiscence viewed on a CBCT surface volume rendered image.

FIG. 4A shows Fenestration viewed on CBCT; whereas FIG. 4B shows Fenestration viewed on a CBCT surface volume rendered image.

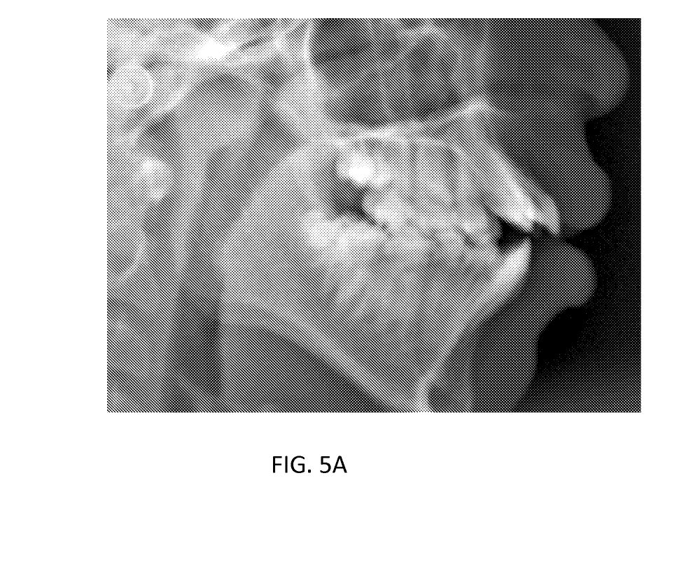

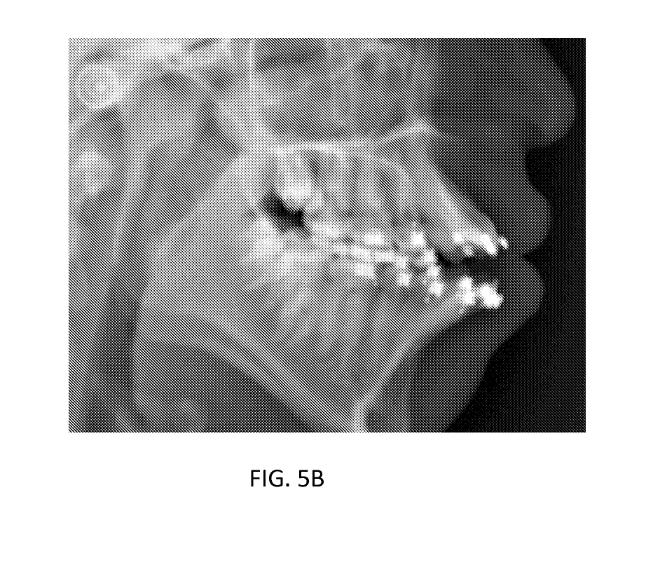

FIG. 5A shows a pretreatment cephalometrics model of a patient; and FIG. 5B shows the mid-treatment cephalometrics model of the same patient. Note that the lower incisors in

FIG. 5B have been severely proclined a result of leveling and use of Class II elastics.

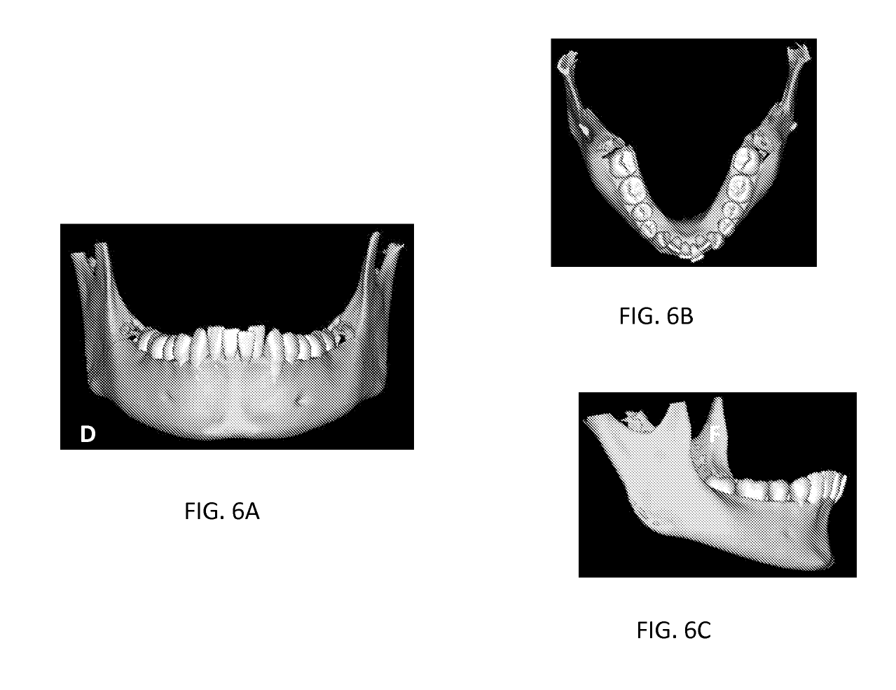

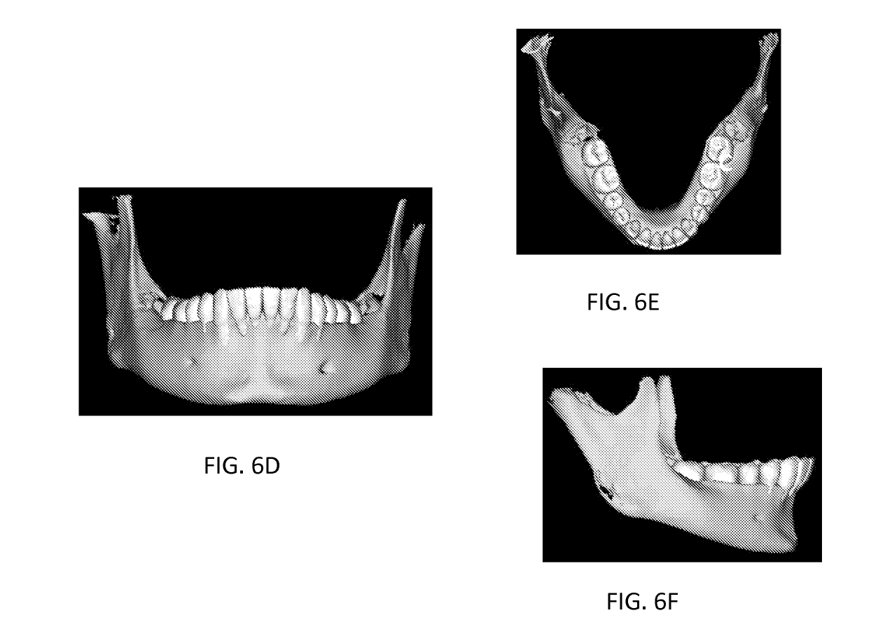

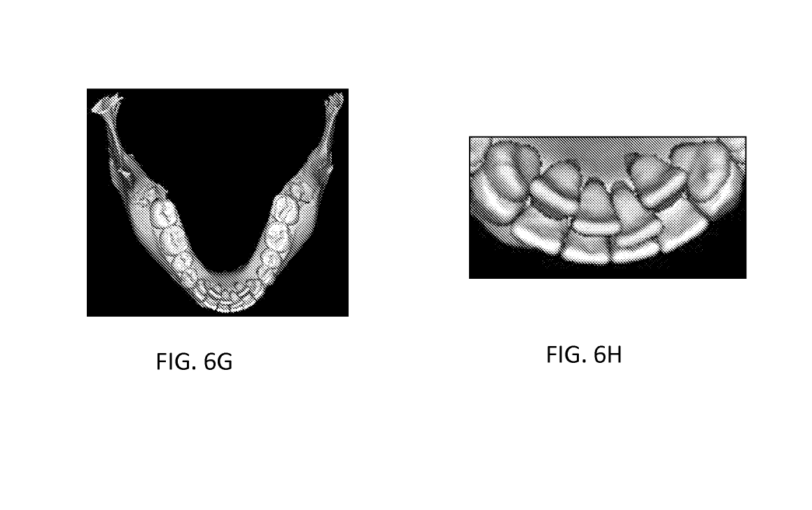

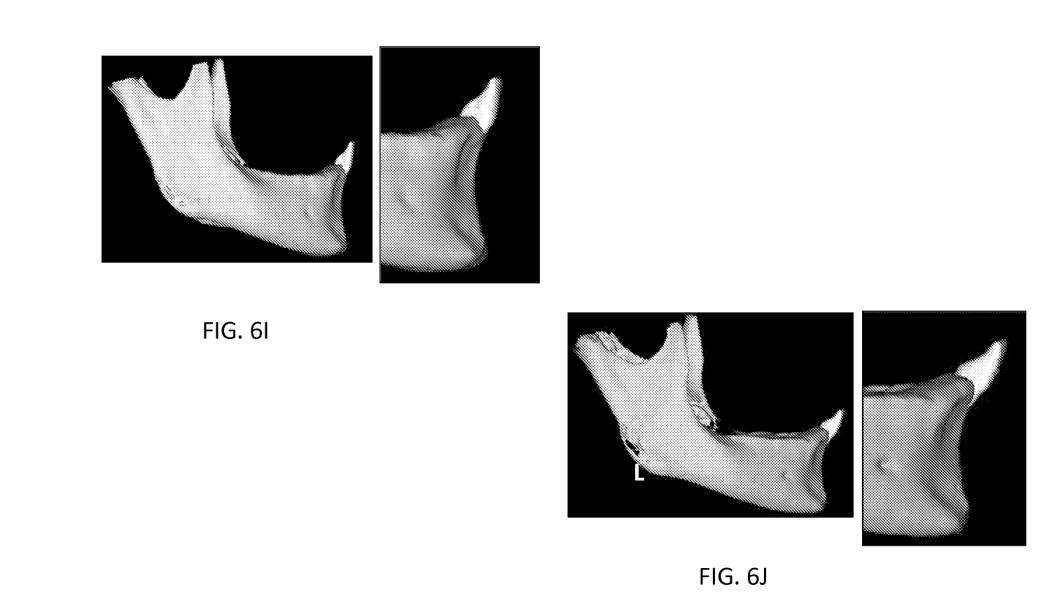

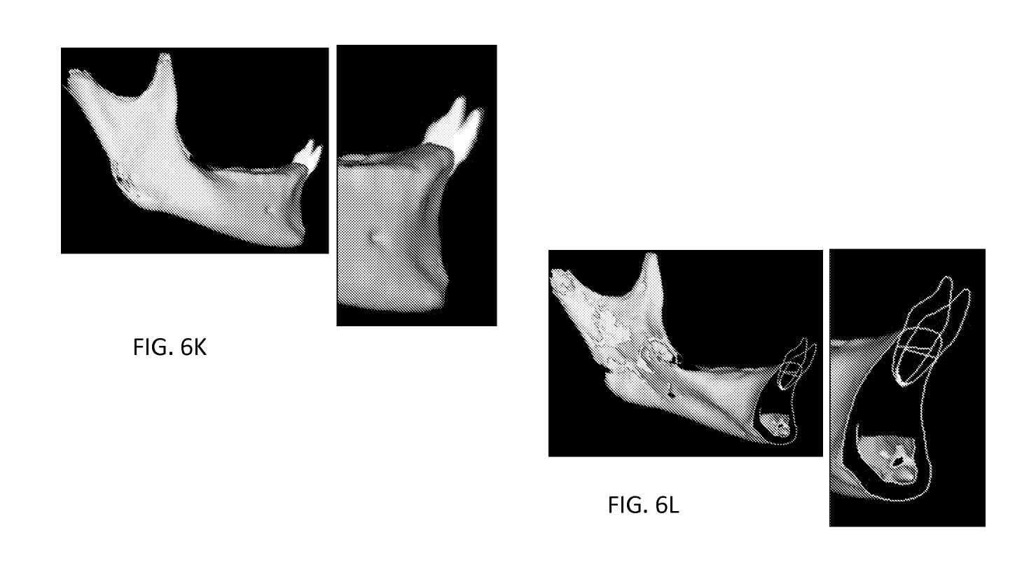

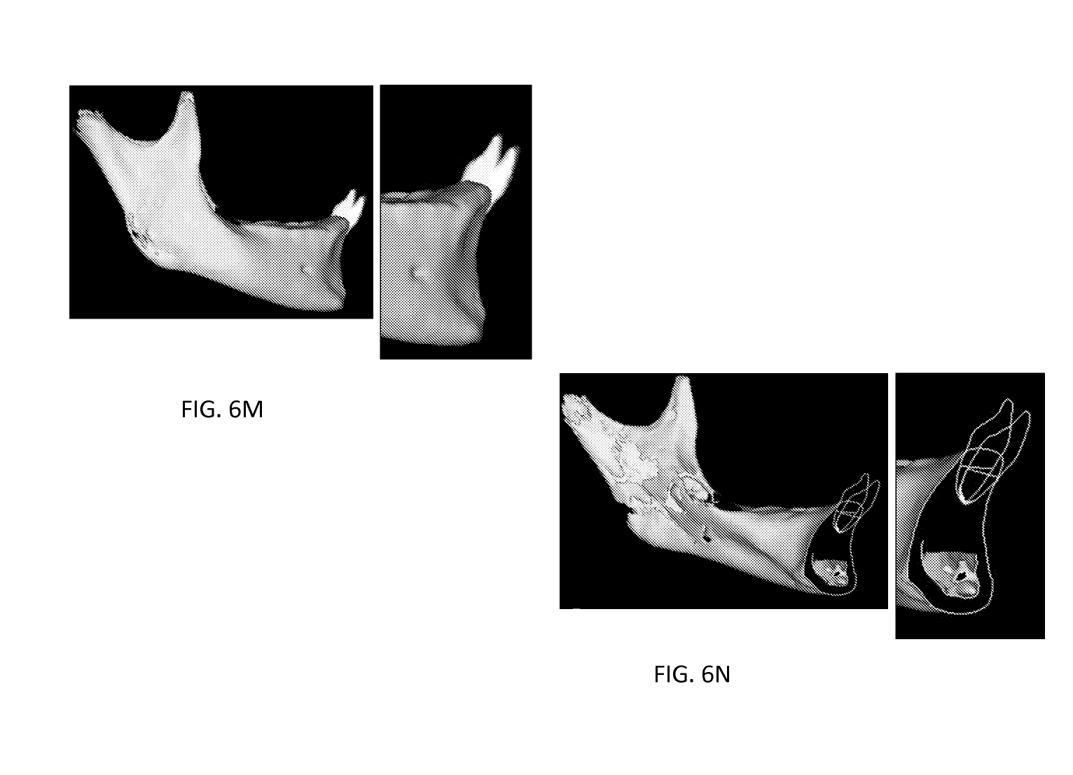

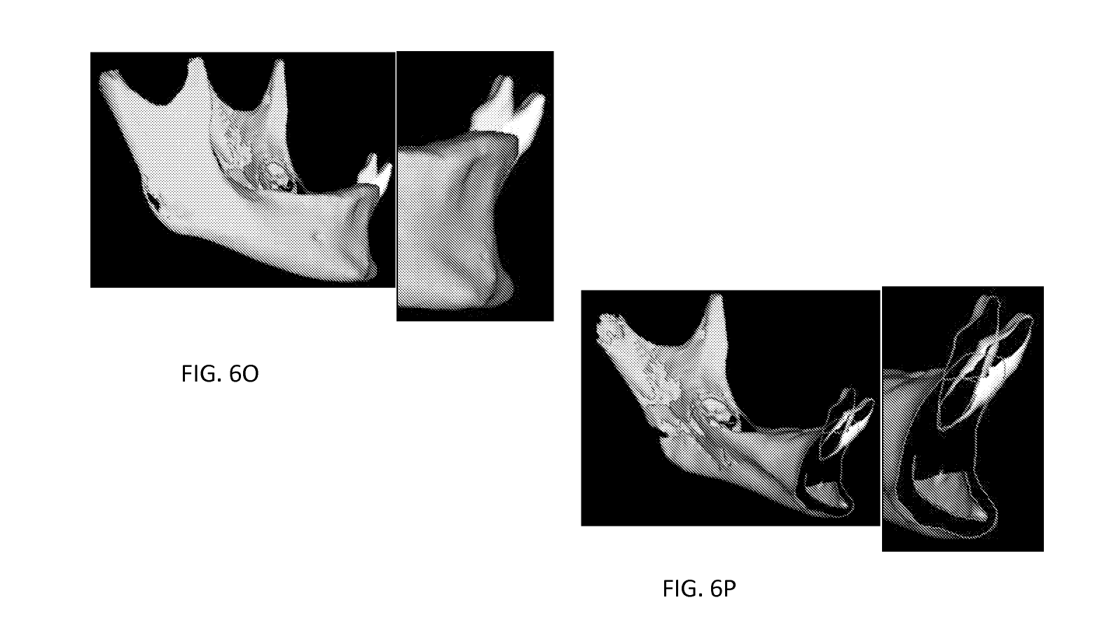

FIGS. 6A, 6B and 6C show dehiscence associated with flaring of incisors of a patient. The models show initial condition of the patient. FIG. 6A shows the labial view, FIG. 6B the occlusal view and FIG. 6C the lateral view of the dentition of the patient. The figures demonstrate mild to moderate crowding in the lower arch of the patient in a deep curve of Spee.

FIGS. 6D, 6E, 6F, 6G and 6H show post treatment alignment and leveling of the teeth of the patient. FIG. 6D shows the labial view, FIG. 6E the occlusal view and FIG. 6F the lateral view of the dentition of the patient. FIG. 6G shows the occlusal view with the after treatment image supper imposed on the image prior to the treatment. FIG. 6H shows an enlarged version of a portion of the view in FIG. 6G. Notice the fenestrations that have developed in lower anterior region as the incisors were tipped forward.

FIGS. 6I-6J show single tooth view of the left mandibular central incisor of the patient. Note that the lower incisor has proclined and moved out of the anterior limits of the mandibular alveolar process. FIGS. 6K-6L show a significant amount of proclination that has occurred with respect to the original incisor position.

FIGS. 6M-6P show the displacement of the lower left lateral incisor. Note the greater amount of tipping that has occurred. This appears to be related to the creation of a larger bone defect.

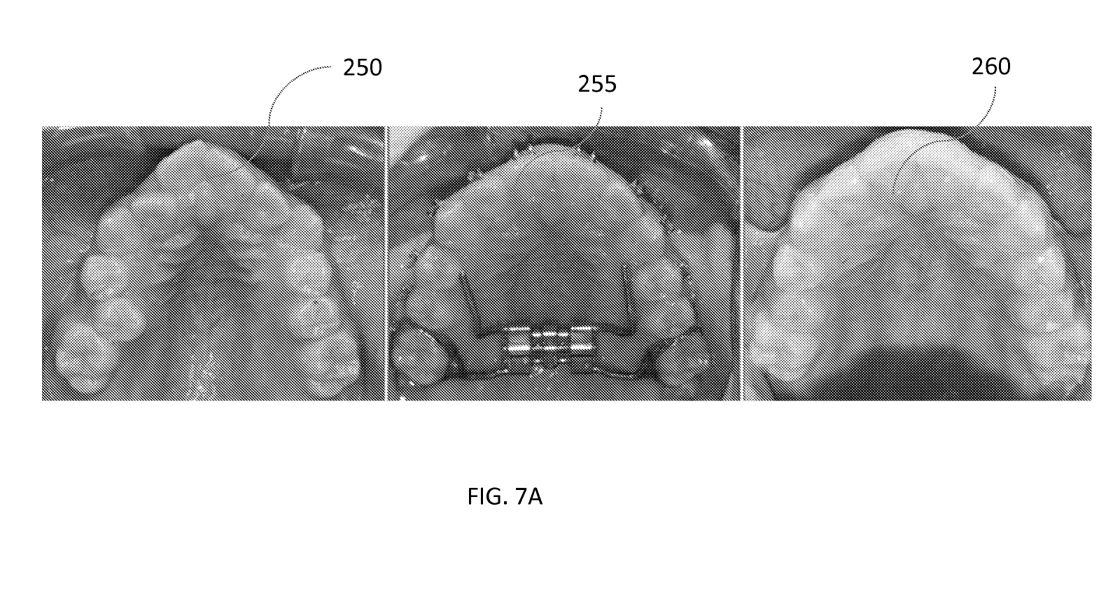

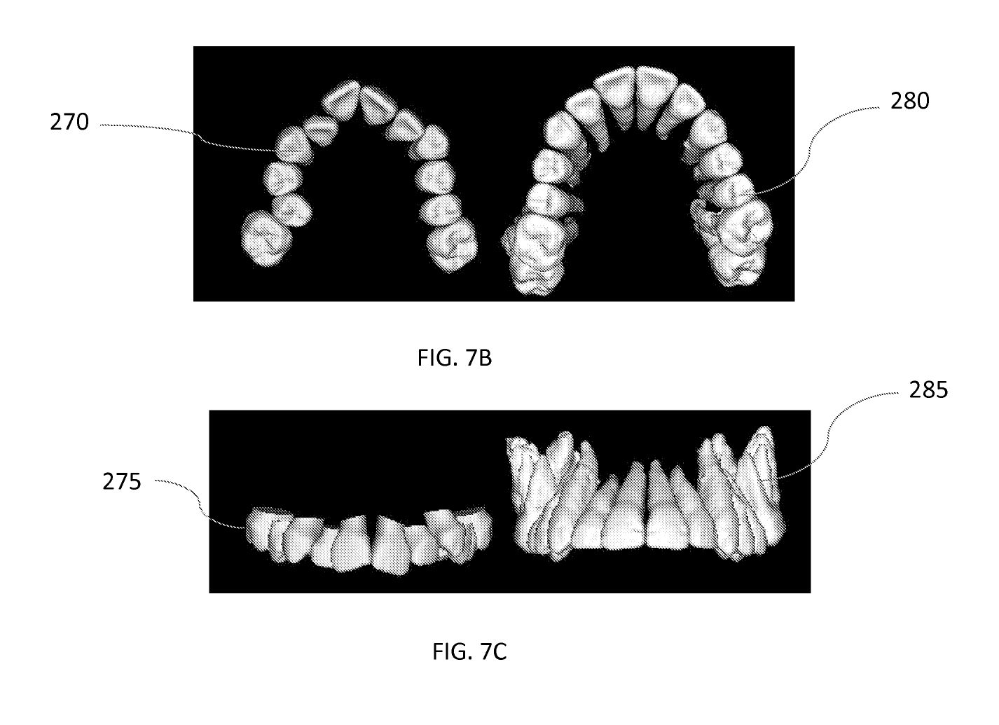

FIG. 7A numeral 250, FIG. 7B numeral 270 and FIG. 7C numeral 275 show patient's images prior to orthodontic treatment. FIG. 7A numeral 255 shows patient's RME image. FIG. 7A numeral 260, FIG. 7B numeral 280 and FIG. 7C numeral 285 show patient's images after the orthodontic treatment. FIG. 7B numeral 270 and FIG. 7C numeral 275 show models created from using a surface scanning device, whereas FIG. 7B numeral 280 and FIG. 7C numeral 285 show models created from combination of images created from a surface scanning device and a volume scanning device such as CBCT. FIG. 7B numeral 280 and FIG. 7C numeral 285 show models with roots showing excessive buccal root tipping as a result of RME. Such tooth movement results in high stresses at the cervical bone margins of the crowns which may promote bone loss.

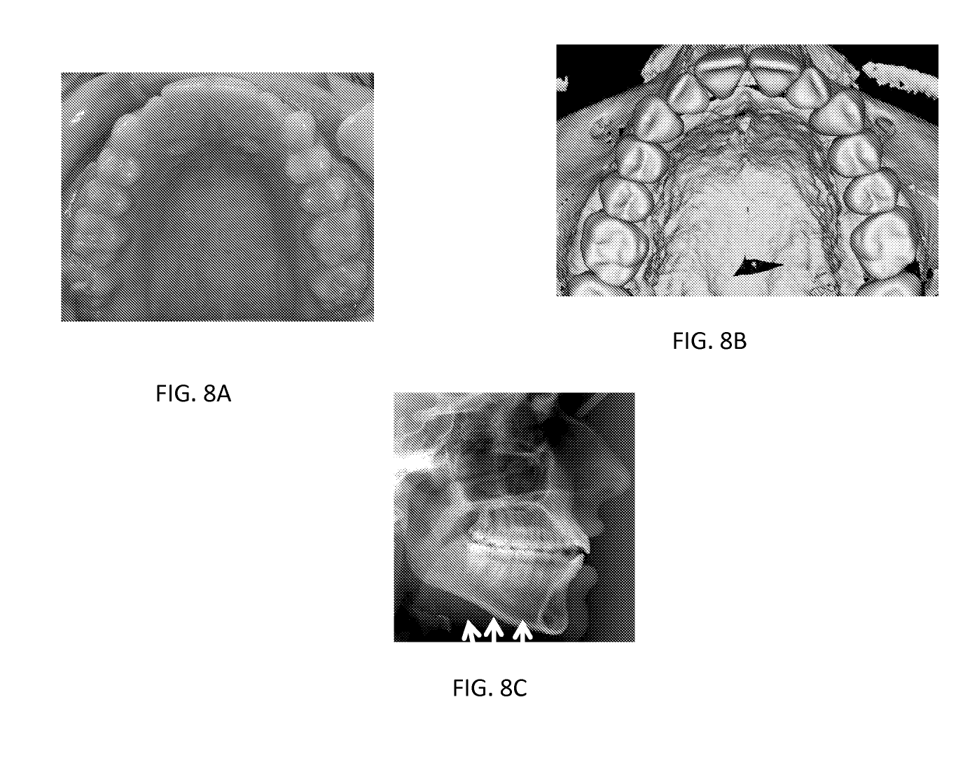

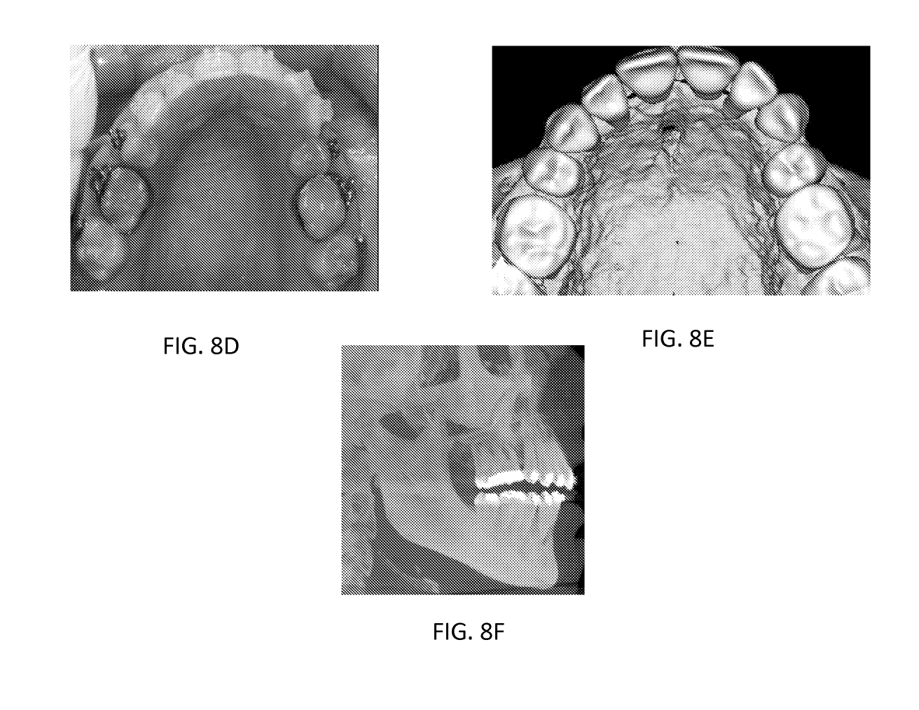

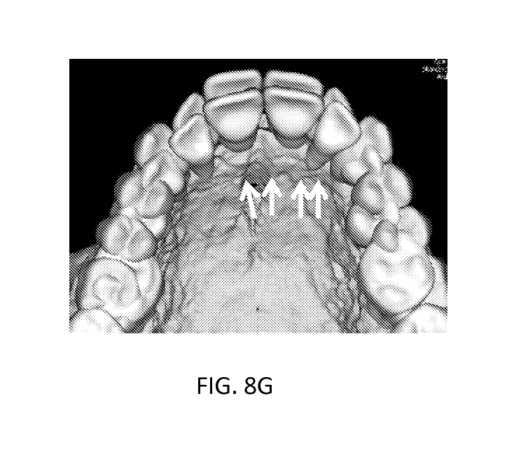

FIGS. 8A-8G show images of palatal cortex response to retraction for a patient. FIGS. 8A-8C show pretreatment images. FIGS. 8D-8F show mid-treatment images with bicuspid extractions. Note, as upper incisors are retracted bone dehiscence in the palatal cortex area is observed. This is not seen clinically or cephalometrically, but, can be seen with a CBCT image. FIG. 8G shows superimposition of initial on the mid treatment images. Note, bone dehiscence in response to upper incisor retraction.

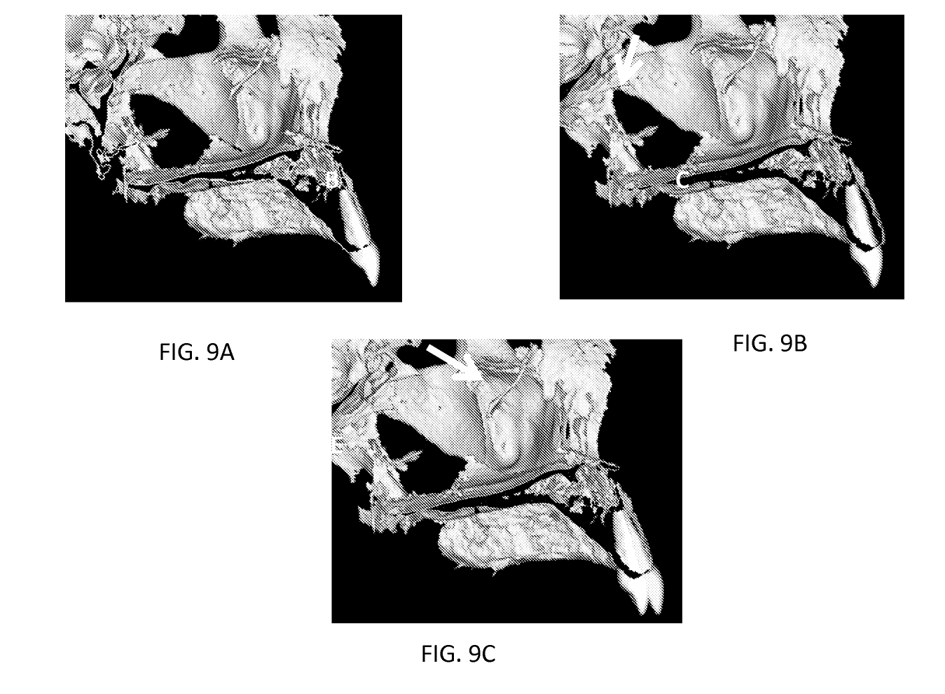

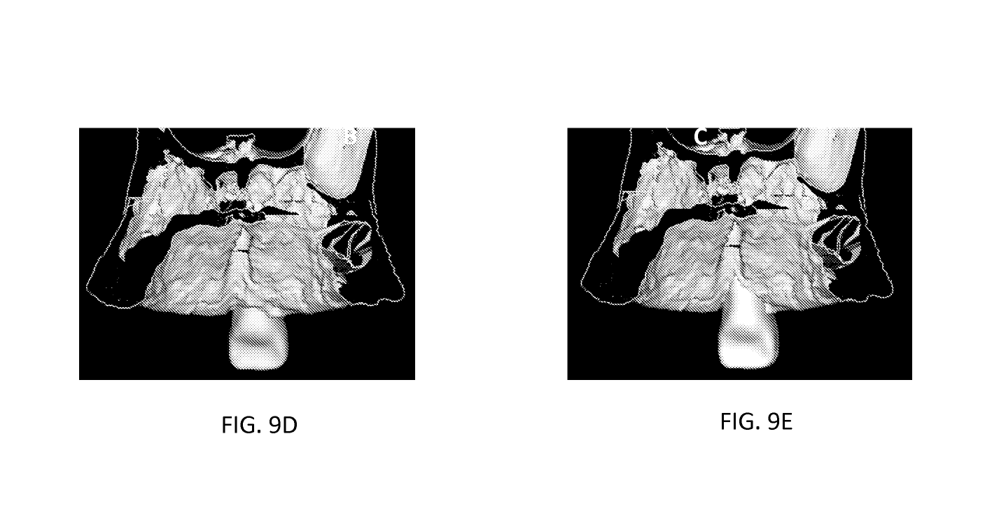

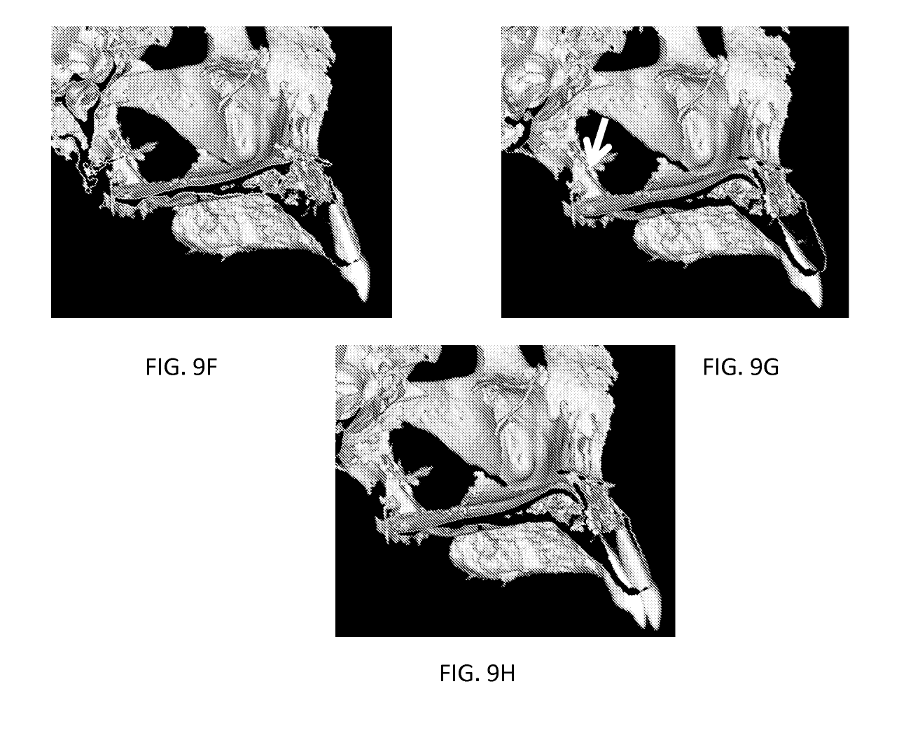

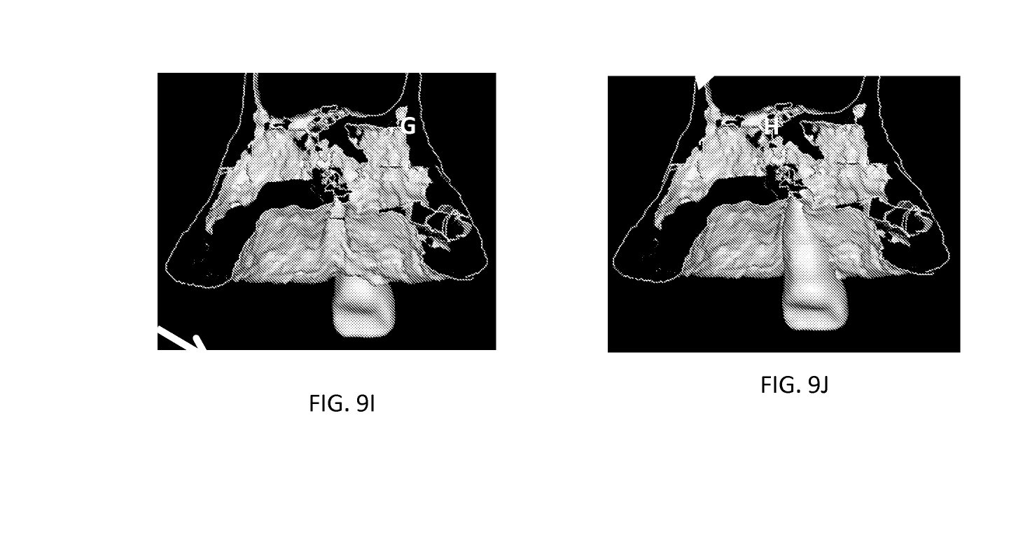

FIGS. 9A-9J show images used in treatment simulation of a patient. Treatment planning software in conjunction with the workstation is used to identify potential risks associated with tooth movement proactively. FIG. 9A shows the initial model. FIG. 9B shows image of retraction simulated with controlled tipping. FIG. 9C shows superimposition of images in FIGS. 9A-9B, thereby showing the displacement from initial to final. In images of FIGS. 9E-9F, note the palatal cortex is partially violated in the mid palatal area. This region has been shown to remodel. Also, note there is no perforation on the labial aspect of the alveolar process. FIGS. 9F-9H show images with a similar amount of retraction of the incisal edge with root movement being simulated. Note, the extensive perforation in the apical part of the root on the palatal in the image of FIG. 9J as compared to initial image in FIG. 9I. It is well known that the apical part of the palatal cortex is resistant to modeling and perforations in this area tend to be permanent.

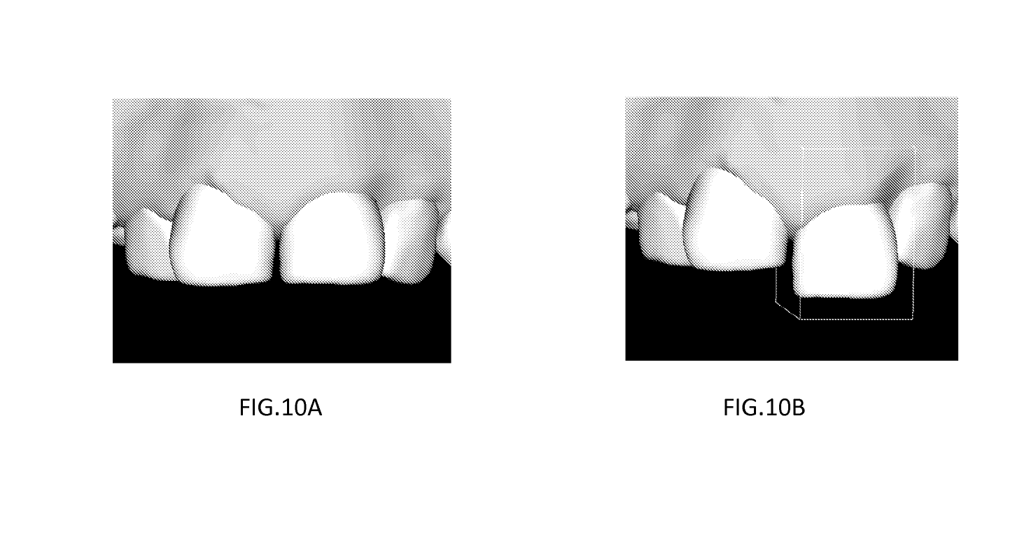

FIGS. 10A-10B show image example of soft tissue constraint. Soft tissue gingival simulation is performed. Gingiva to tooth movement ratio set at 1:1. FIG. 10A shows initial tooth model, whereas FIG. 10B shows that gingival level has moved occlusally at the same level of the tooth.

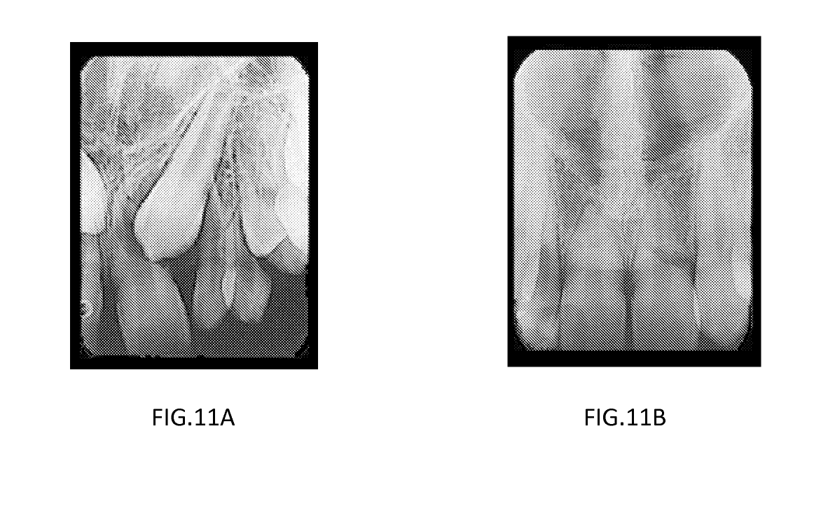

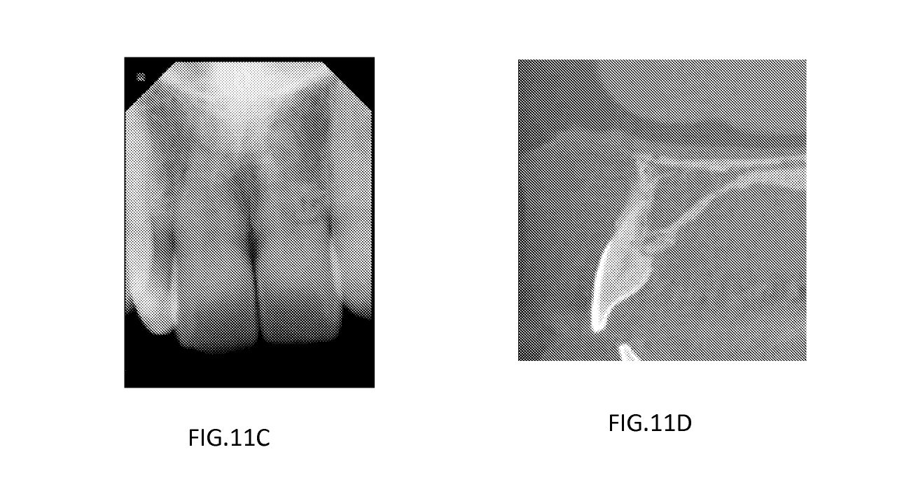

FIGS. 11A-11D show image examples of root constraint. Note the neighboring tooth collision can cause root resorption.

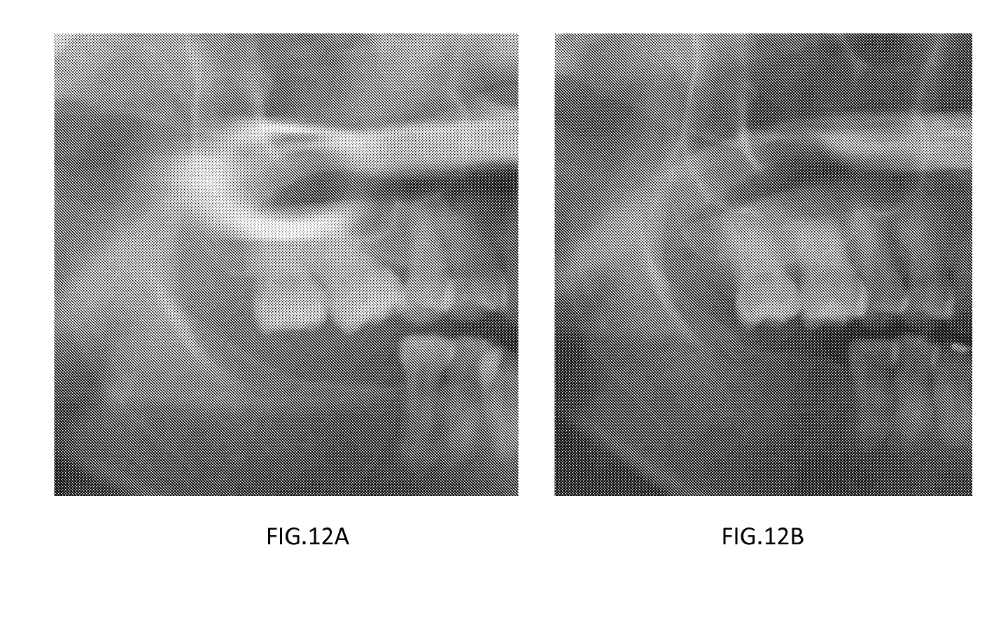

FIGS. 12A-12B show image examples of anatomical constraint. Maxillary sinus can cause another biological constraint. Note the sinus has remodeled in the image of FIGS. 12B.

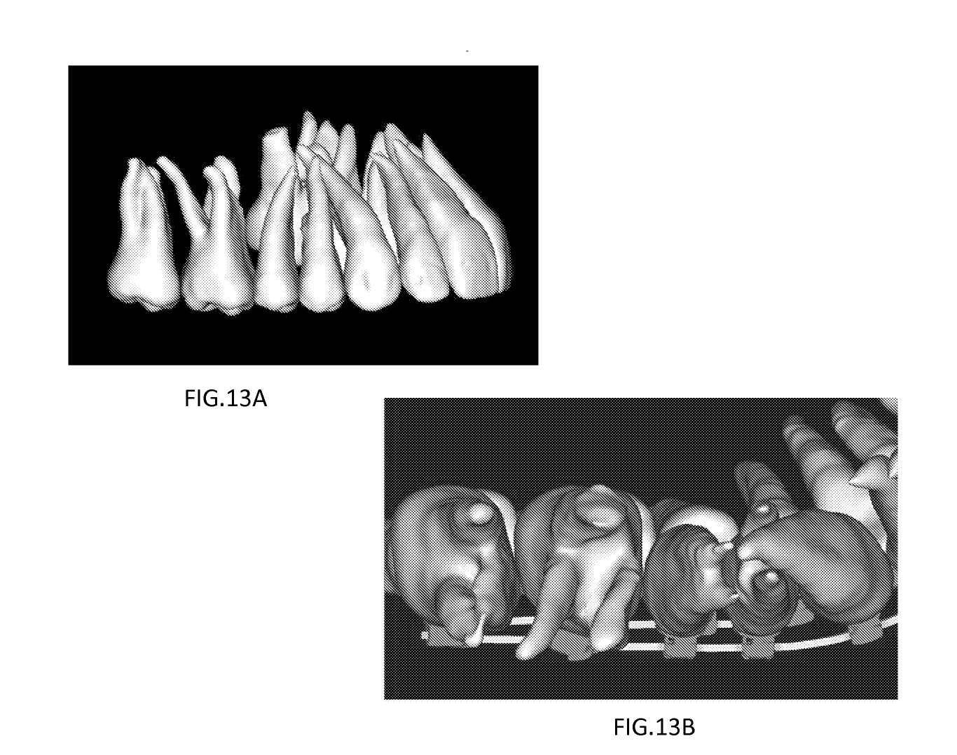

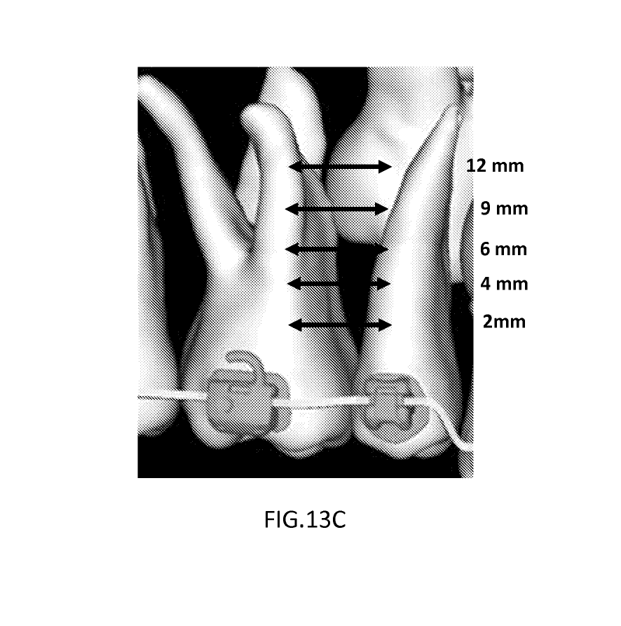

FIGS. 13A-13B show image examples of root constraint. Note the root collision which can cause a biological constraint and needs to be corrected. FIG. 13C shows that root dilaceration can measured manually or automatically at any level.

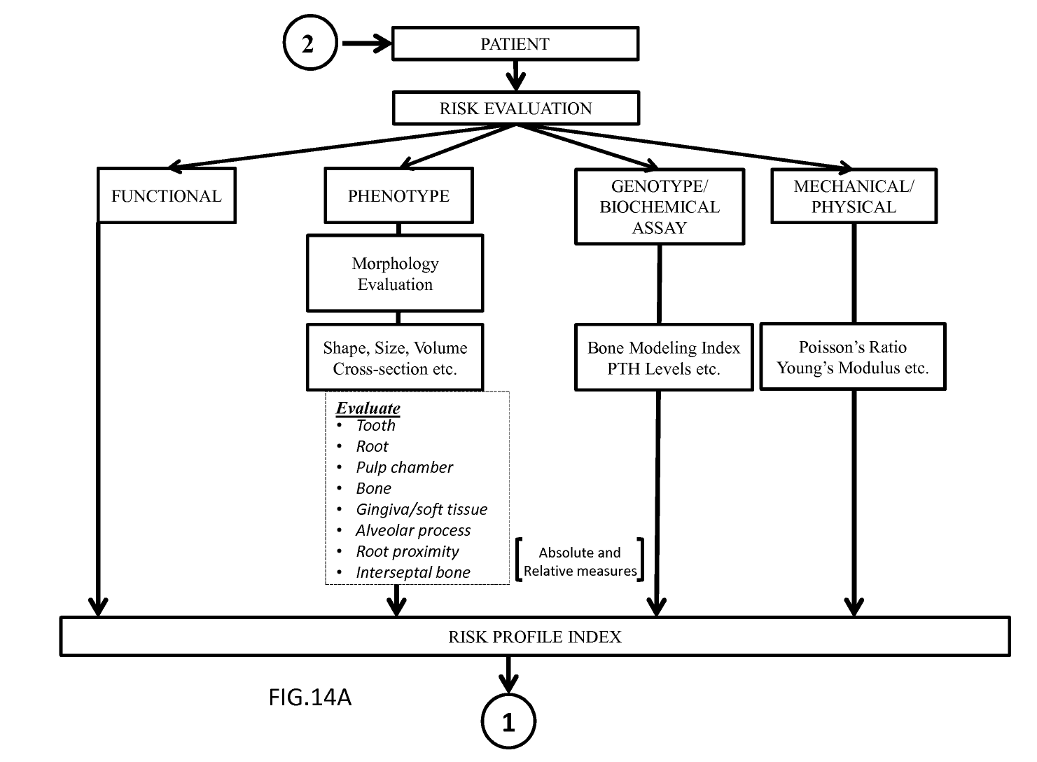

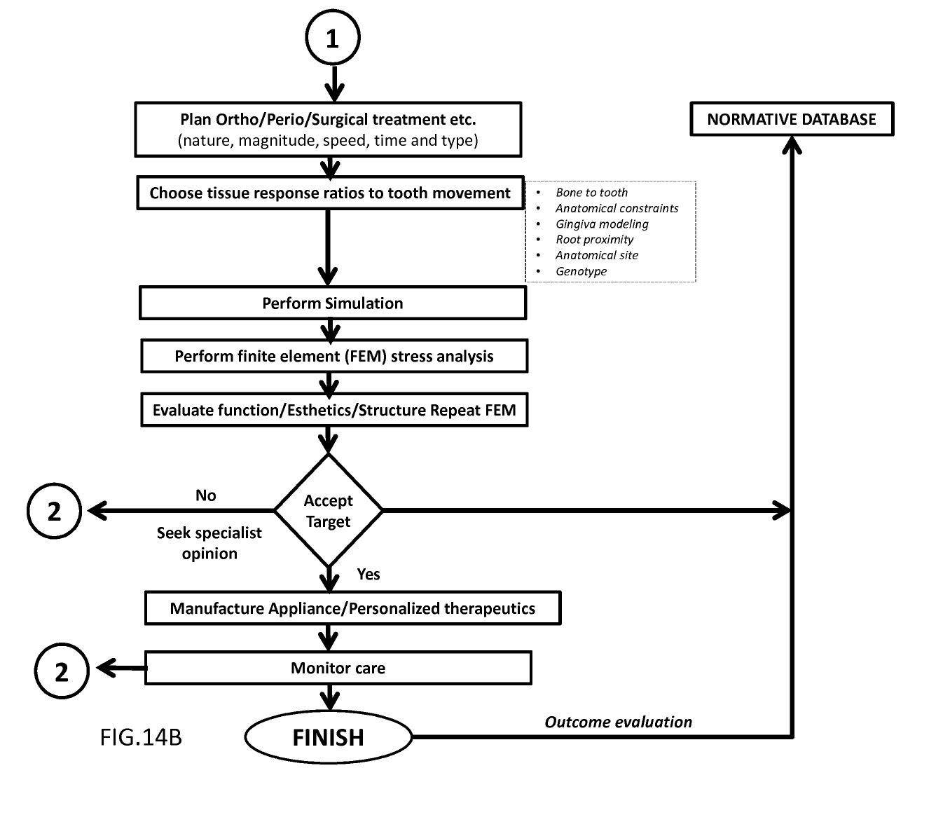

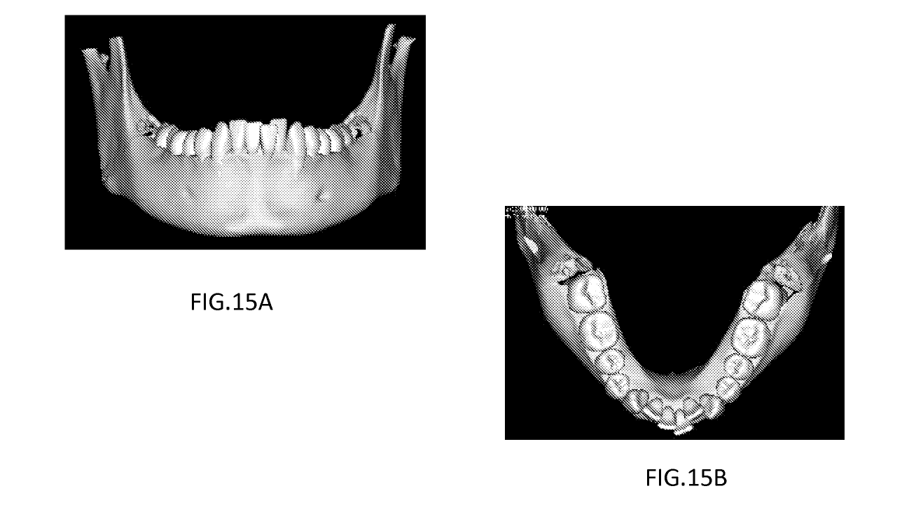

FIGS. 14A-14B show block diagrams of the treatment planning procedure disclosed in embodiment of the invention.

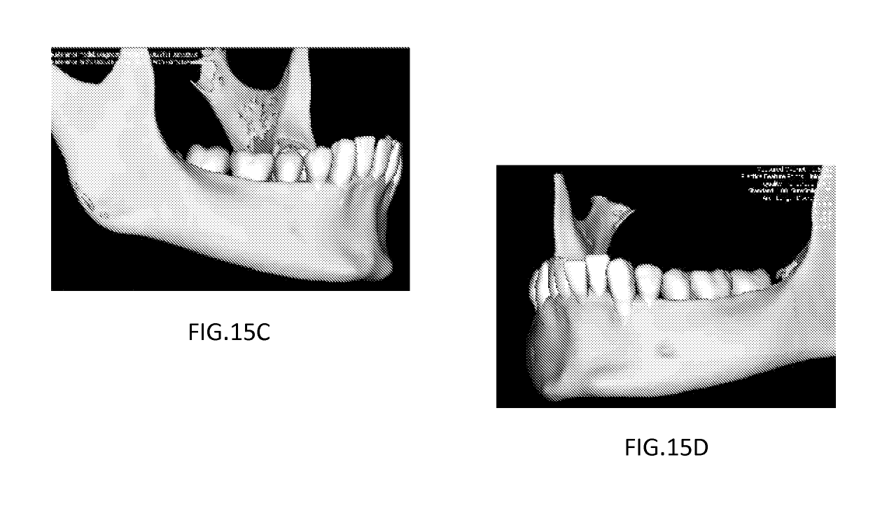

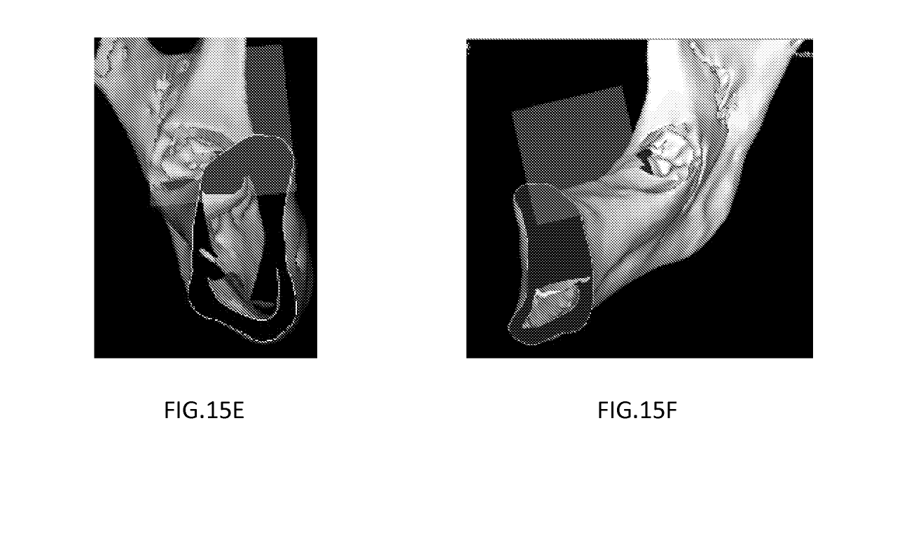

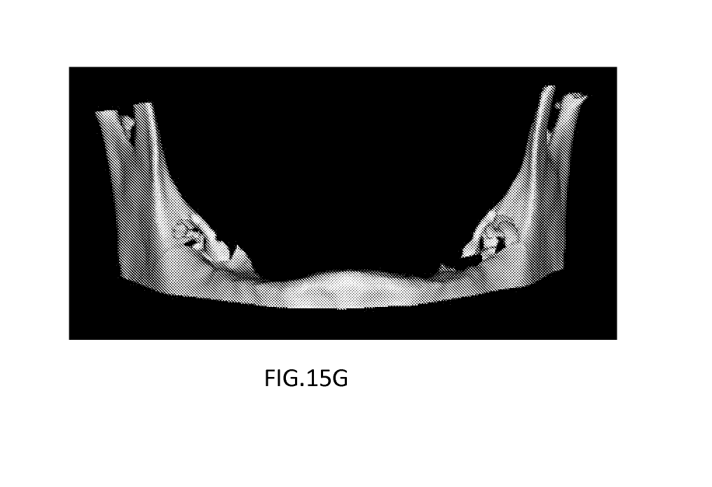

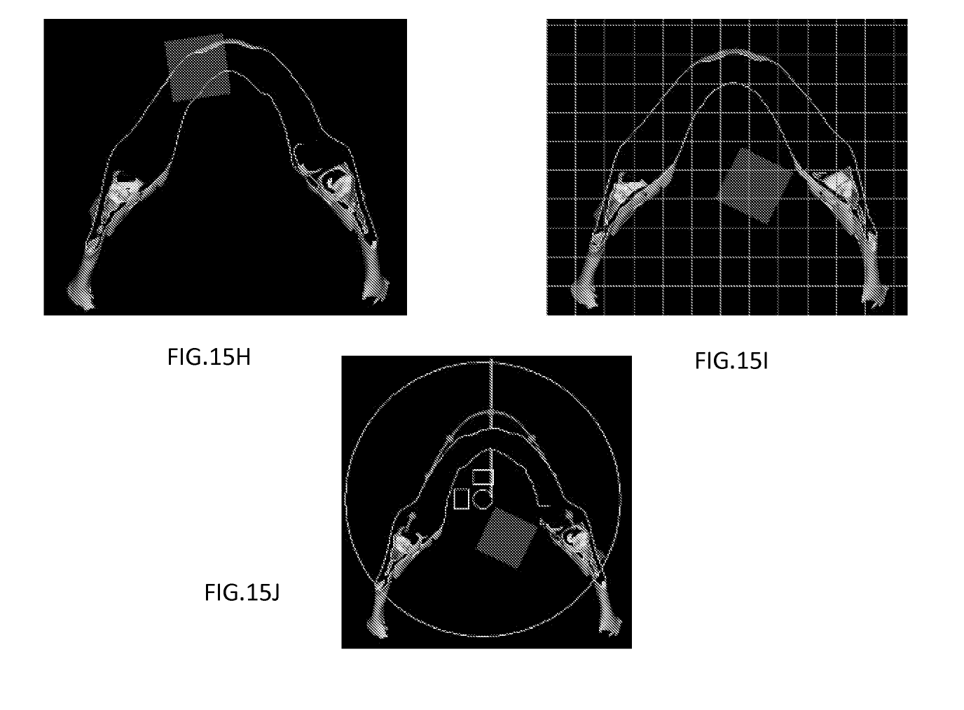

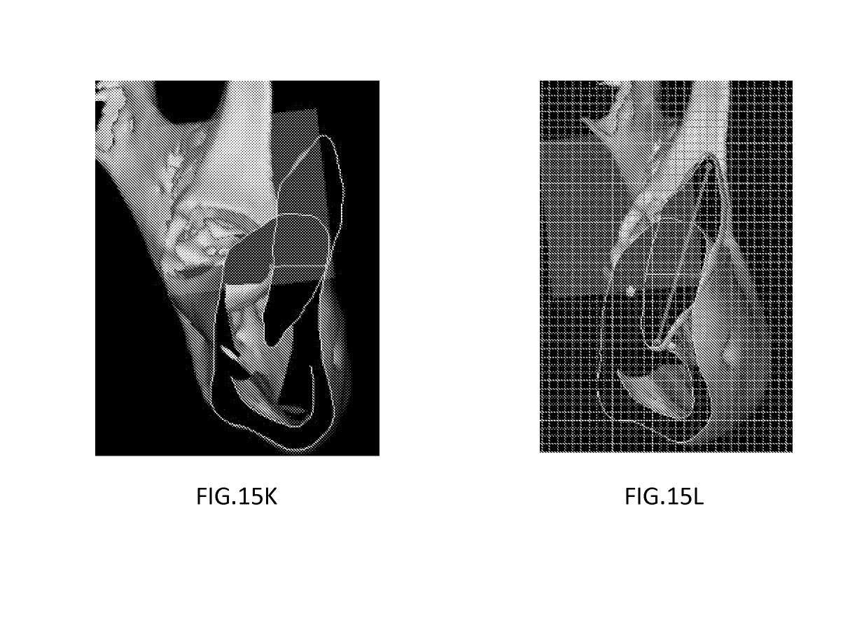

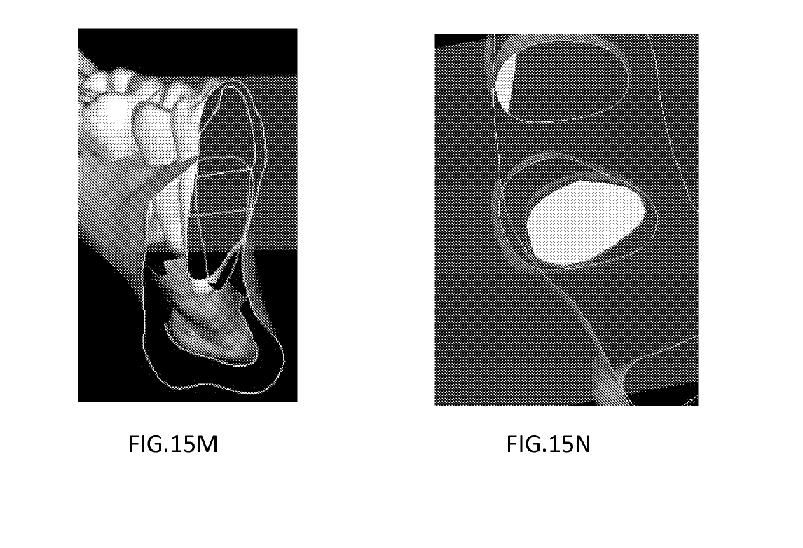

FIGS. 15A-15N show images for evaluation of morphology. FIGS. 15A-15D show images of initial models. In the image shown in FIG. 15B, note the initial crowding in lower arch. FIG. 15C shows image of the lower left canine substantially in the bone. In the image shown in FIG. 15D, note lower left canine out of bone. FIGS. 15E-15F show mandibular alveolar bone shape analysis in canine area cross section of the image in FIG. 15E. Mandibular left bone appears thicker in the image in FIG. 15F. Mandibular right bone appears thinner in the image of FIG. 15D. Note lower left canine out of bone. FIGS. 15G-15J show images of bone shape evaluation at different levels (frontal view). FIG. 15G shows 3 mm below CEJ level. FIG. 15H shows Occlusal view 2 mm below CEJ level. FIG. 15I shows Occlusal view 8 mm below CEJ level. FIG. 15J shows comparison of bone shape against symmetrical object to evaluate asymmetry in shape, FIGS. 15K-15N show images for evaluating position of lower left canine in bone (sagittal view). FIG. 15M shows normative size tooth from database evaluation against patient. Note that the patient tooth is much larger and out of bone. Diagnosis is that canine is out of bone because the tooth size is large and the bone is thin. FIG. 15N shows normative tooth size compared to patient's lower left canine (occlusal view).

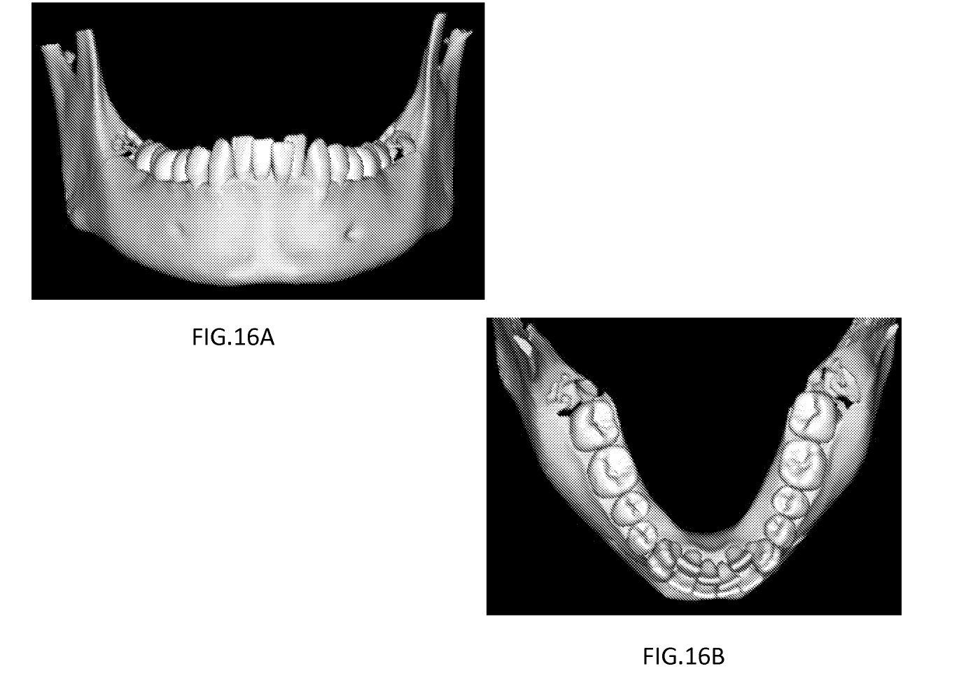

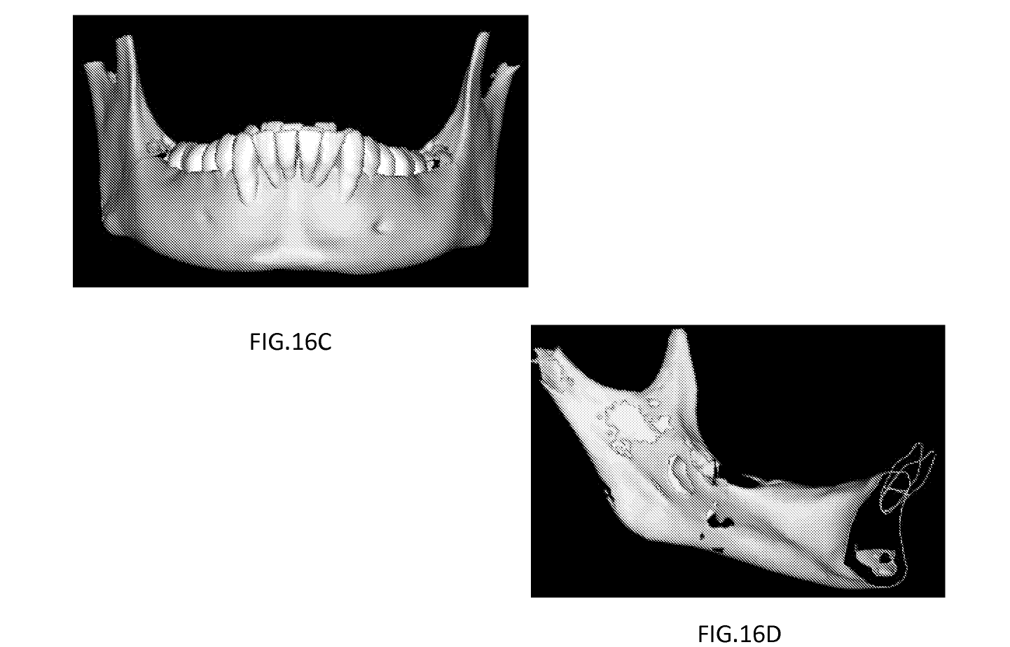

FIGS. 16A-16D show images for risk evaluation. FIG. 16A shows initial (pretreatment) image. Note that lower incisors in bone and crowding. FIGS. 16B-16C show lower arch treatment, original (blue) compared to final (white). Note the position of lower incisors pulled out of bone after treatment (C). FIG. 16D shows sagittal view showing the effect of treatment (teeth pulled out of bone).

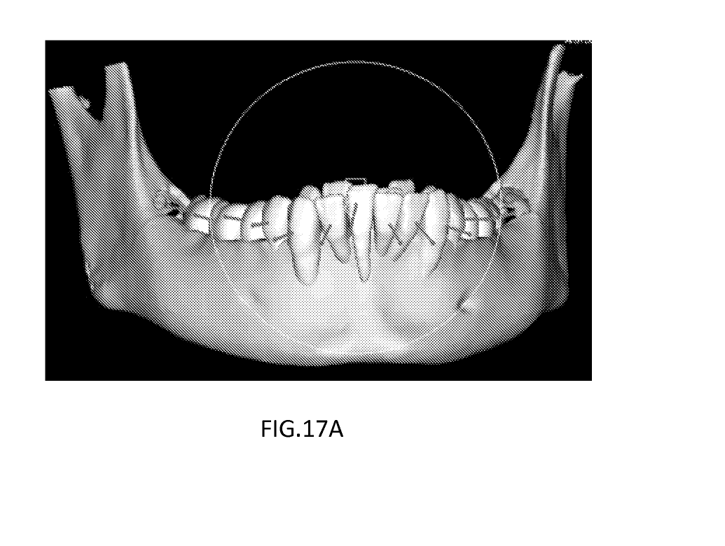

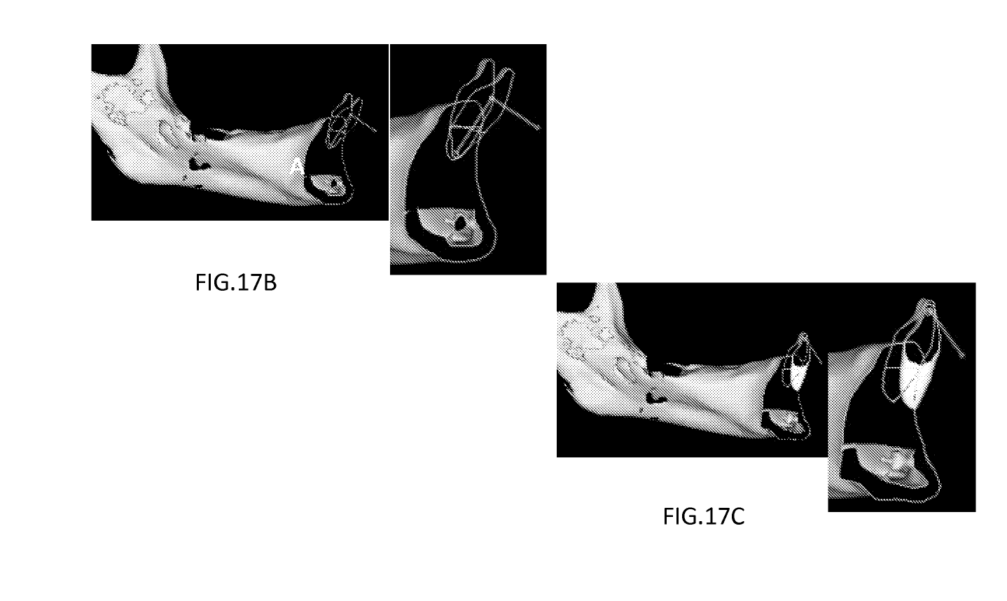

FIGS. 17A-17C show simulation images showing changing nature of tooth movement and evaluating bone tooth movement response. Bone tooth (BT) movement ratio applied 0.2:1, FIG. 17A shows simulation visualized from frontal view. Note incisor out of bone. FIG. 17B shows center of rotation at root apex. FIG. 17C shows center of rotation at incisal edge. Note extreme buccal bone perforation.

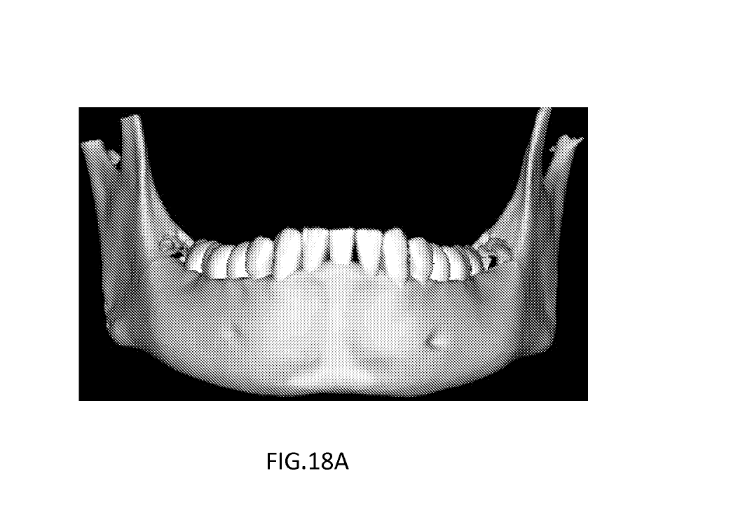

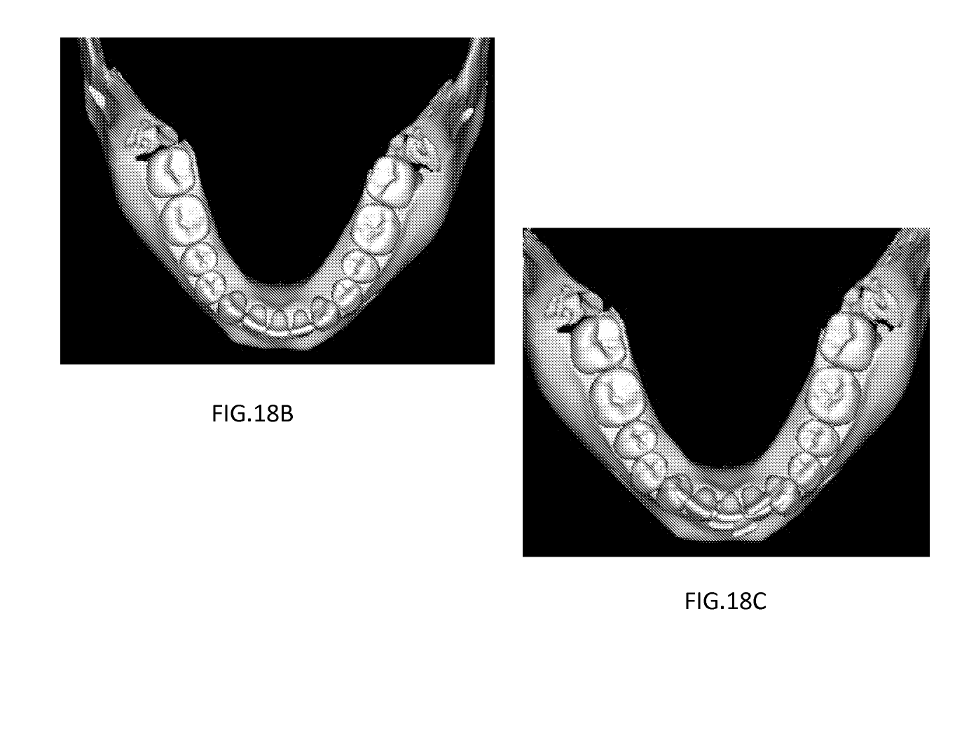

FIGS. 18A-18C show simulation images of lower incisor extraction with Bone tooth (BT) movement ratio applied 1:1. Note that no bone loss (FIG. 18A) and teeth maintained in bone and crowding resolved (FIGS. 18B-18C). FIG. 18A shows frontal view. FIG. 18C shows comparison of lower incisor crowding, initial (blue) and simulation (white).

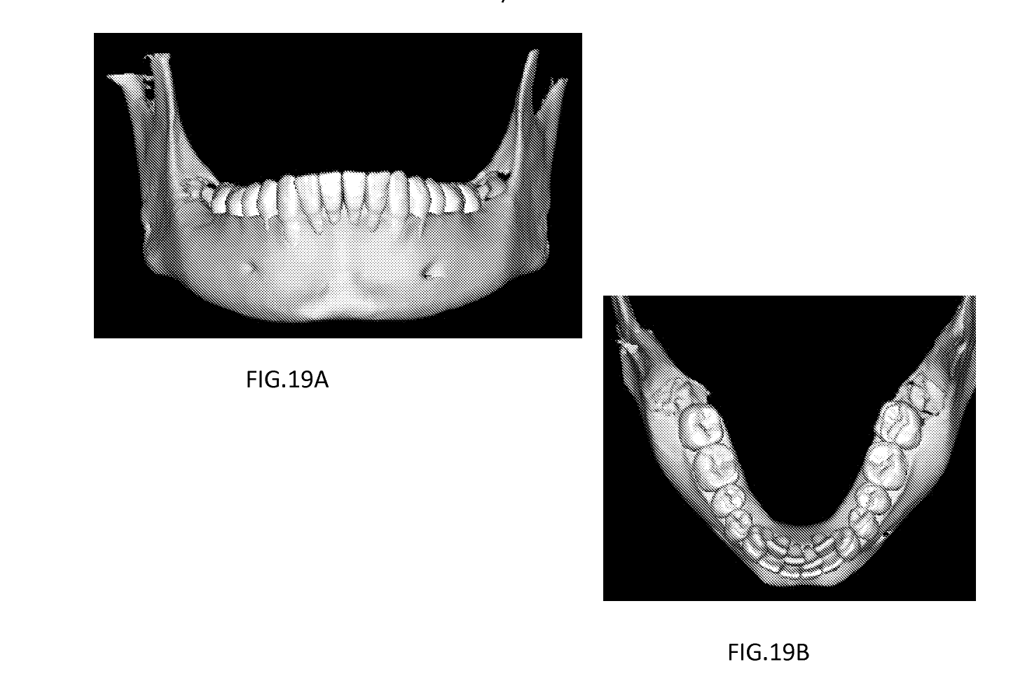

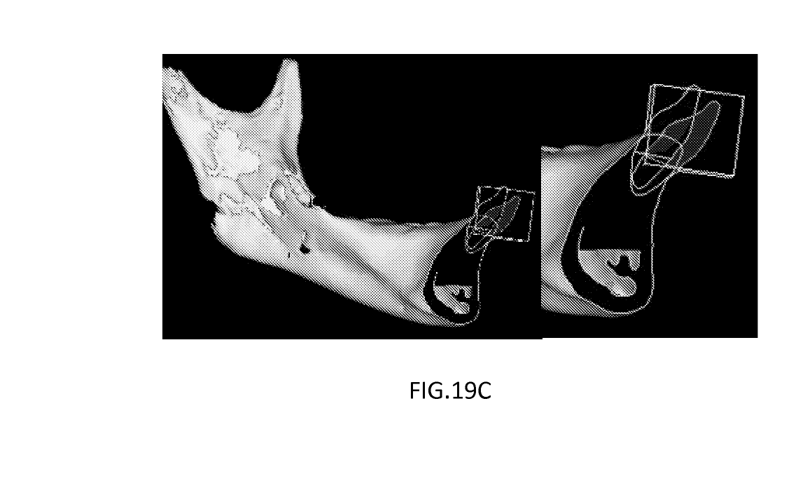

FIGS. 19A-19C show images for predicted prognostic simulation similar to actual outcome. FIG. 19A shows frontal view. Note the teeth out of bone. FIG. 19B shows crowding resolved. Predicted prognostic simulation based upon patient evaluation (risk factors) and normative database. FIG. 19C shows tooth movement type in relationship to appliance and risk profile index. Note the anticipated center of rotation at apex of root. B:T ratio predicted is 0.4:1.

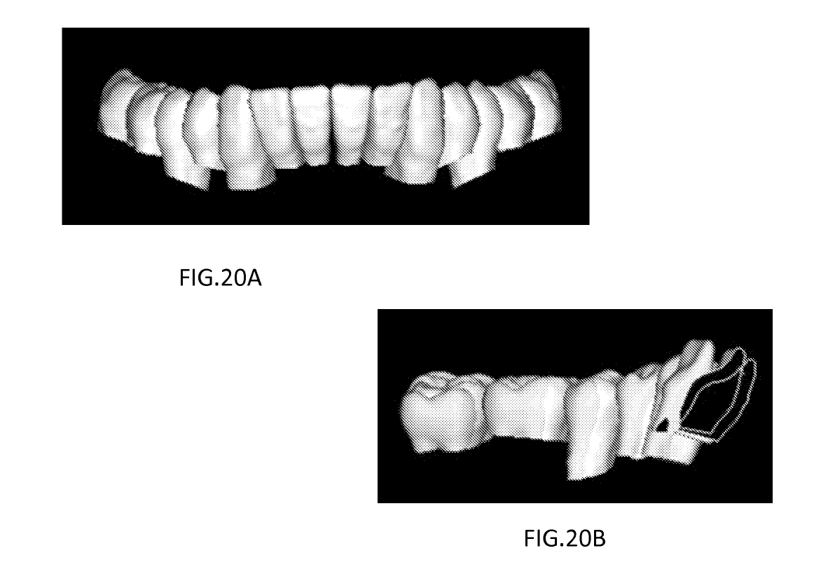

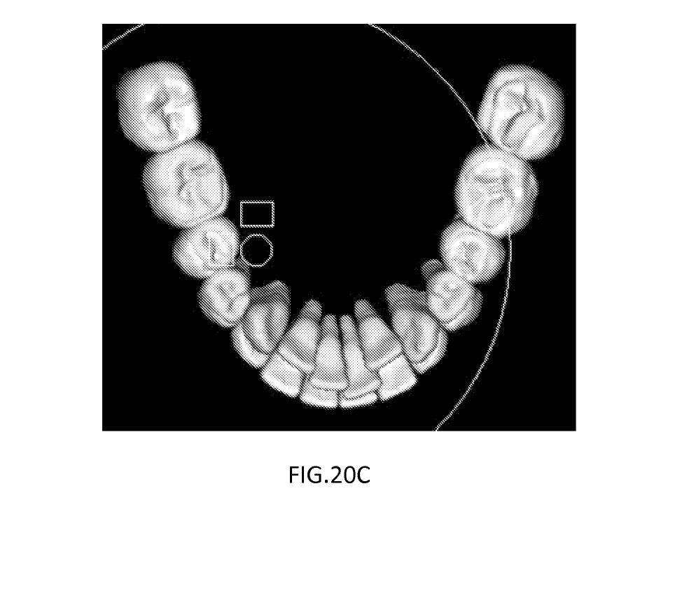

FIGS. 20A-20C show images without roots or bone data used in this simulation. FIG. 20A shows that one cannot evaluate root bone relationship with simulation if root and bone data is not available. FIG. 20B shows unability to determine risk of root proximity to bone. FIG. 20C shows crowding resolved, but, it is impossible to evaluate the position of roots with respect to bone.

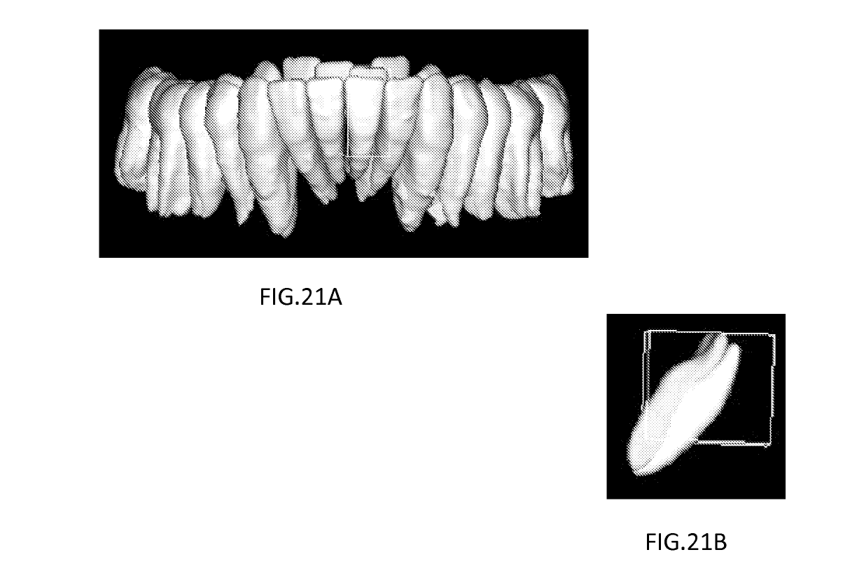

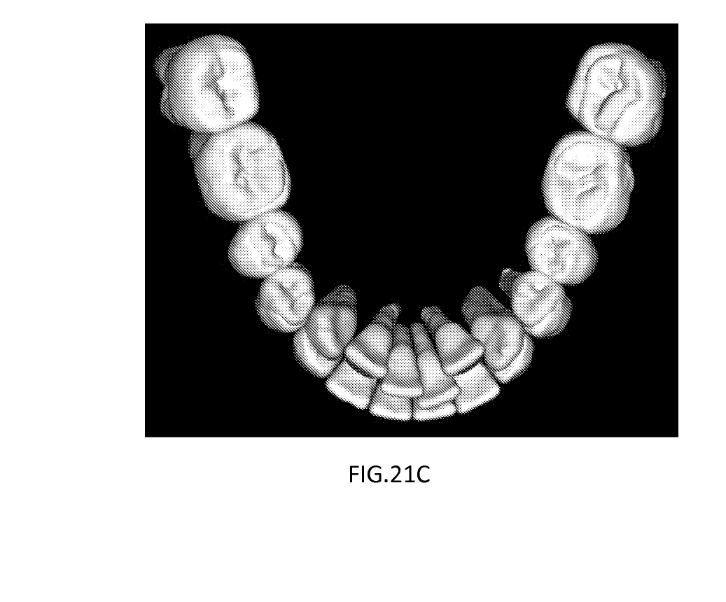

FIGS. 21A-21C show images of only root data used in this simulation. FIG. 21A shows that one can only evaluate root to root relationship and not to bone. FIG. 21B shows that it is not possible to evaluate bone response or relative position of root to bone. FIG. 21C shows that it is impossible to evaluate bone and soft tissue response.

Before describing the features of this invention in detail, an overview of a unified workstation will be set forth initially. The workstation provides software features that create two dimensional and/or three-dimensional virtual patient model on a computer, which can be used for purposes of communication, diagnosis, treatment planning and design of customized appliances in accordance with a presently preferred embodiment.

The essence of the invention disclosed herein is the ability to

FIG. 40 A-B show the risk evaluation process for planning orthodontic treatment according to the preferred embodiment of the invention. Risk evaluation is categorized in functional, phenotype, genotype and mechanical/physical categories; and a risk profile index is created. Treatment simulation is done and appliances manufactured per the accepted target treatment. Subsequently monitoring of the patient's progress is done as the treatment progresses. The monitored results are further used to update the patient's profile and to make the necessary treatment adjustments.

FIG. 41 A-B Example of soft tissue constraint. Soft tissue gingival simulation. Gingiva to tooth movement ratio set at 1:1. A. Initial tooth. B. Gingival level has moved occlusally at the same level of the tooth

FIG. 42 Example of root constraint. Note the neighboring tooth collision can cause root resorption

FIG. 43 A-B Example of anatomical constraint A&B. Maxillary sinus can cause another biological constraint. Note the sinus has remodeled (B)

FIG. 44 A-C Example of Root constraint A&B. Note the root collision which can cause a biological constraint and needs to be corrected. C. Root dilaceration can measured manually or automatically at any level

FIG. 45 A-F Evaluation of Morphology. A-D. Initial models. B. Note initial crowding in lower arch. C. Lower left canine substantially in bone. D. Note lower left canine out of bone. E&F. Mandibular alveolar bone shape analysis in canine area cross section E. Mandibular left bone appears thicker F. Mandibular right bone appears thinner

FIG. 45 G-J Bone shape evaluation at different levels (frontal view). G. 3 mm below CEJ level. H. Occlusal view 2 mm below CEJ level. I. Occlusal view 8 mm below CEJ level. J. Comparing bone shape against symmetrical object to evaluate asymmetry in shape

FIG. 45 K-N. Evaluating position of lower left canine in bone (sagittal view). M. Normative size tooth from database evaluation against patient. Note. Patient tooth much larger and out of bone. Diagnosis is that canine is out of bone because the tooth size is large and the bone is thin. N. Normative note the tooth size compared to patient's lower left canine (occlusal view)

FIG. 46 A-D. Risk Evaluation. A. Initial (Pretreatment). Note. Lower incisors in bone and crowding. B&C. Lower arch treatment, original compared to final. Note position of lower incisors pulled out of bone after treatment (C). D. Sagittal view showing the effect of treatment (teeth pulled out of bone)

FIG. 47. A-C. Simulation showing changing nature of tooth movement and evaluating bone tooth movement response. Bone tooth(BT) movement ratio applied 0.2:1, A. Simulation visualized from frontal view. Note incisor out of bone. B. Center of rotation at root apex. C. Center of rotation at incisal edge. Note extreme buccal bone perforation.

FIG. 48 A-C Simulation of lower incisor extraction with Bone tooth(BT) movement ratio applied 1:1. Note. No bone loss (A) and teeth maintained in bone and crowding resolved (B&C). A. Frontal view. C. Comparison of lower incisor crowding, Initial was compared with simulation.

FIG. 49 A-C Predicted prognostic simulation similar to actual outcome. A. Frontal view. Note teeth out of bone. B. Crowding resolved. Predicted prognostic simulation based upon patient evaluation (risk factors) and normative database. C. Tooth movement type in relationship to appliance and risk profile index. Note. anticipated center of rotation at apex of root. B:T ratio predicted 0.4:1

FIG. 50 A-C No Root or bone data used in this simulation. A. Cannot evaluate root bone relationship with simulation if root and bone data is not available. B. Unable to determine risk of root proximity to bone. C. Crowding resolved. But, it is impossible to evaluate the position of roots with respect to bone.

FIG. 51 A-C Only Root data was used in this simulation. A. Can only evaluate root to root relationship and not to bone. B. Not possible to evaluate bone response or relative position of root to bone. C. It is impossible to evaluate bone and soft tissue response

The preferred embodiment of the invention combines volume scan data with surface scan data to get the benefit of both and compensate for weaknesses of each.

The advantages of volume scan data are (i). acquisition of invisible data (CBCT & MRI) such as (a) roots, bone, condile, Airways; whereas the advantages of the surface scan data are high accuracy and resolution on visible surfaces.

The goal of the invention is to obtain (a.) high accuracy representation of visible areas, especially small features on teeth, (b) representation of gingival, (c) representation of tooth roots, (d) representation of bones, (e) representation of condole, and (f) representation of brackets, all in very high precision 3-D modeling by combining surface scan data with the volume scan data.

In summary, method and workstation for generating three dimensional digital or virtual model of the dentition and surrounding anatomy of a patient from surface scan data and volume scan data are disclosed. Surface scans of a patient's dentition are obtained using in-vivo scanning or other types of scanning such as scanning an impression of the patient's dentition or scanning a physical model of the patient's dentition. Volume scan data of the patient's dentition are obtained using Cone Beam Computed Tomography (CBCT) or Magnetic Resonance Tomography (MRI) imaging equipment. By registering the surface scan data with the volume scan data three dimensional models of a patient's dentition and surrounding anatomy including roots, bones, soft tissues, airways, etc. are obtained.

First and foremost the essence of the patent is the ability to capture images from various sources, e.g., CBCT, cat, MRI, fmri, ultrasound, still photos, intraoral scanners and videos both static and dynamic.

With these images a composite structure of the face can be constructed dynamic or static We can also track function or jaw movement and simulate the functional movements eg smile movement of the lower jaw, etc.

Most importantly from the CBCT one can extract root, and bone data and soft tissue, and if there is any attached appliance, such as orthodontic brackets, without taking multiple images, in one sweep and process each component to create separate objects to use for treatment planning and customized appliance selection or design and manufacture. The simulations allow user to reposition any component, e.g., bone, soft tissue, tooth with roots, with respect to each other in a measured way and chosen reference planes. Furthermore, one can change and restore both the shape and form of any of the structures to modify the appearance of any of these structures, e.g., tooth shape or gum tissue, etc. These changes both in terms of position and shape can be driven by external data, e.g., templates, normative data, internal data, the non-affected side of the patient or combination thereof.

One can also replace or remove any of the structures to achieve the desired goal, e.g., implants or extraction.

In essence one can reposition, restore, replace or remove any of the objects. The codependency of movement of one object and its effect on another can also be simulated for all three tissue types, e.g., when the tooth moves how does it affect the gum soft tissue, when the tooth moves where does the root move in reference to the bone or how does the bone change, how does the face change when the bones move. As a result, all types of planning can be executed by various professions in an interactive manner asynchronously or synchronously. These may include the orthodontist, maxillofavcial surgeon, prosthodontist, perodontist, restorative dentist. Also function can be simulated or modeled based upon captured data to achieve the desired goals, e.g., the teeth with their roots can be appropriately positioned in the bone to withstand the stresses of jaw movement or that the position of the jaw joint, i.e., the condyle is in harmony with the position of the teeth to prevent any source of dysfunction. All these simulation involve natural anatomical structures being affected in 3D space with volumetric data or in combination with 2D data when appropriate.

The treatment plan can be used to generate any kind of dental, orthodontic, restorative, prosthodontic or surgical device, tissue borne, dental borne, osseous borne or any combination thereof, singularly in serial or in parallel. Some devices e.g., brackets, indirect bonding trays, stents, fixation plates, screws, implants, surgical splints, crown implants, prosthetic devices, dentures or prosthetic parts to replace or restore any tissue can be manufactured by stereo-lithography milling or build up processes. Furthermore, this data can be used to drive navigational systems for performing any procedure and simulations can be used to train and build skills or examine proficiency. As another example, the output can be used to drive robots to perform procedures. Lastly, the treatment plan can be printed to provide a solid model representation.

Registration can be made at three levels. One is the orientation of the face, secondly the orientation of any component soft tissue to teeth or bone by using appropriate reference planes that are user defined or anatomically defined, and finally the bite registration by taking the intramural scan and registering the CBCT to it or a scan of the bite registration material, e.g., wax and registering to it. Treatment planning is done with true anatomical structures, such as roots; and with freedom to plan around, or with any chosen object. The procedure does not fuse a model of the dentition into the crank facial structure; but captures all in one shot and extracts individual features, such as roots and soft tissue, etc. One can capture the dental and osseous and soft tissue as one and segregate them into individual components for planning.

The optimization of the treatment plan can be accomplished by using different approaches, e.g., correcting crowding by minimizing tooth movement and planning veneers or minimizing tooth preparation for veneer construction by positioning the teeth appropriately. This can be the for any structure and the decision can be driven by the patients need, time constraints, cost risk benefit, skill of operator, etc.

The process to extract roots based on well-known concepts is as follows:

1. Interactively, select a good threshold value which captures the roots.

2. Extract the surface or surfaces identified in step 1, representing them as triangles.

3. Interactively, apply any needed clean up—remove unwanted data and merge any needed, disconnected fragments.

4. Interactively, separate the data (triangles) into separate, individual tooth objects.

5. Interactively, apply any needed clean up to each tooth object.

The bone surface can be extracted similarly, as follows:

1. Interactively, select a good threshold value which captures the mandible, maxilla, and potentially, the teeth.

2. Extract the surface or surfaces identified in step 1, representing them as triangles.

3. Interactively, apply any needed clean up—remove unwanted data and merge any needed, disconnected fragments.

4. Using boolean (set) operators, subtract the tooth objects from the extracted surfaces.

5. Interactively, separate the mandible from the maxilla by removing any edges and triangles which connect one to the other.

This process can be executed in any of various available tools that can read a CBCT data set (DICOM) and find an iso-surface based on a threshold value. One such software tool is Amira.

In another embodiment, an apparatus is disclosed comprising, in combination, a computer-readable medium storing data representing a unified three dimensional virtual craniofacial and dentition model of actual, as-is static and functional anatomy of a patient, the data comprising:
(a) data representing facial bone structure of the patient including the upper jaw and lower jaw;
(b) data representing facial soft tissue of the patient;
(c) data representing teeth including crowns and roots of the patient, the data including information of the position of the roots relative to each other and relative to the facial bone structure of the patient including the upper jaw and the lower jaw;
wherein the data representing parts (a), (b) and (c) of the unified three dimensional virtual craniofacial and dentition model of the patient are constructed solely from digital data obtained by scanning as-is anatomy of craniofacial and dentition structures of the patient with a volume scanning device;
(d) data representing three dimensional virtual models of the patient's upper and lower gingiva, wherein the data represent three dimensional virtual models of the patient's upper and lower gingiva are constructed from scanning the patient's upper and lower gingiva either (a) with a volume scanning device, or (a) with a surface scanning device; the data (d) subsequently associated with data (c); and
(e) data representing function of the patient's jaw movements and smile; wherein the data representing function of the patient's jaw movements and smile are obtained through video imaging, jaw tracking, or photographs;
wherein data (a), (b), (c), (d) and (e) are represented in the medium as individual static and/or dynamic anatomical object(s) of the patient; and
a viewing program for viewing data (a), (b) (c), (d) and (e) on a display of a workstation wherein data (a), (b) (c), (d) and (e) can be displayed individually or in any combination on command of a user of the workstation using the viewing program.

The volume scanning device can be a cone beam computed tomographic (CBCT) scanner; or an ultra-sound scanner; or a magnetic resonance imaging (MRI) scanner or a fMRI scanner; or an optical scanner; or an ultra sound scanner; or a camera.

The function capturing device can be a video camera; or a telemetric jaw tracking device.

The as-is anatomy of the patient includes any dental borne appliance, bone borne appliance, or soft tissue borne appliance.

The dental borne appliance includes brackets, dental restorations, dental prosthesis and endodontic root posts. The bone borne appliance includes implants, temporary anchorage devices, bone screws, fixation plates, and condylar prosthesis. The soft tissue borne appliance includes obturators, and soft tissue implants and prosthesis.

In another embodiment of the invention, a method of planning comprehensive treatment of a patient is disclosed. The patient may have a craniofacial deformity, skeletal abnormalities, soft tissue abnormalities, dental malocclusion, and/or dysfunction. A practitioner can plan the treatment using a workstation comprising a computing platform having a graphical user interface, a processor and a computer storage medium containing digitized records pertaining to the patient, the digitized records including image data, and a set of software instructions providing graphical user interface tools for access to the digitized records.

The method comprises the steps of:

(a) loading into the workstation a unified three dimensional virtual craniofacial and dentition model of the patient; wherein the unified three dimensional virtual craniofacial and dentition model comprises:
(i) facial bone structure including upper jaw and lower jaw;
(ii) facial soft tissue;
(iii) teeth including crowns and roots; wherein the roots are positioned relative to each other and relative to bones of the upper jaw and bones of the lower jaw;
(iv) upper and lower gingiva; and
(v) data representing function of the patient's jaw movements and smile;

wherein the data representing function of the patient's jaw movements and smile are obtained through video imaging, jaw tracking, or photographs; wherein the virtual model comprising elements from (i), (ii), (iii), (iv) and (v) are individual and separate data objects and viewable individually or in any combination via the graphical user interface;

(b) examining the unified three dimensional virtual craniofacial and dentition model of the patient;

(c) identifying one or more abnormalities requiring surgery for correcting the one or more abnormalities in the patient's craniofacial and/dentition;

(d) creating a post-surgery desired setup of the patient's teeth, including movements of one or more of the teeth and movements within the bone structure, for curing the malocclusion;

(e) creating a pre-surgical setup of the patient's teeth while retaining the movements of one or more of the teeth, but removing the movements within the bone structure; both from the post-surgery desired setup;

(f) creating a pre-surgical setup of the patient's teeth while retaining the movements of one or more of the teeth, but removing the movements within the bone structure;

(g) adjusting the movements of one or more of the teeth in the pre-surgical setup thereby allowing room for the surgery for removing the one or more abnormalities; and creating adjusted pre-surgical setup;

(h) designing orthodontic appliances for the patient in accordance with the adjusted pre-surgical setup;

(i) designing orthodontic appliances for the patient in accordance with the post-surgical setup;

(j) designing surgical appliances for the patient in accordance with the pre-surgical setup;

(k) designing surgical appliances for the patient in accordance with the post-surgical setup; and

(l) sending data for manufacturing appliances.

In the method described above, parts (i), (ii) and (iii) of the unified three dimensional virtual craniofacial and dentition model of the patient in step (a) are constructed solely from digital data obtained by scanning as-is anatomy of craniofacial and dentition structures of the patient with a volume scanning device; wherein the volume scanning device is either a cone beam computed tomographic (CBCT) scanner, or an ultra-sound scanner, or a magnetic resonance imaging (MRI) scanner.

Further in the method described above, part (iv) of the unified three dimensional virtual craniofacial and dentition model of the patient in step (a) is constructed from digital data obtained by scanning the patient's upper and lower gingiva either (i) with a volume scanning device, or (ii) with a surface scanning device; and subsequently integrated with three dimensional virtual models of the teeth; wherein the volume scanning device is either a cone beam computed tomographic (CBCT) scanner, or an ultra-sound scanner, or a magnetic resonance imaging (MRI) scanner; and wherein the surface scanning device is either an in-vivo scanner, or a laser scanner.

Further in the method described above, the orthodontic appliances include one or more orthodontic appliances attached to or placed upon the teeth; and/or the bones; and/or the soft tissue inside the patient's mouth. The orthodontic appliances include one or more orthodontic brackets bonded to the teeth; on the basis of one bracket per tooth.

The method may include the step of consulting with one or more specialists, wherein the one or more specialists are selected from a list of specialists depending upon the one or more deficiencies identified in the patient's craniofacial and/dentition; wherein the list of specialists comprise (i) pediatric dentist, (ii) dentist, (iii) orthodontist, (iv) oral surgeon, (v) plastic surgeon, and (vi) other specialists during one or more steps of the treatment planning comprising steps (b) through (f). The consulting is done with the aid of sharing the unified three dimensional virtual craniofacial and dentition model of the patient with the one or more specialists via a computer network. Even the patient can participate in the consulting session.

In the method described above, step (e) can be replaced with pre-surgical simulations for generating pre-surgery setup.

The treatment plan to alleviate the identified one or more deficiencies comprise one or more procedures selected from a list of procedures; wherein the list of procedures comprises (i) surgery including oral, facial, bone, cleft, palate, etc. (ii) one or more teeth extractions, (iii) one or more teeth implants, (iv) curing malocclusion, (v) inserting crowns, (vi) designing artificial teeth, including dentures, etc.

On the other hand the treatment plan may comprise one or more veneers and/or crowns or restorations; wherein matching of tooth-color for each of the one or more veneers, crowns or restorations is realized utilizing the procedure comprising the additional steps of: (a) obtaining a digital color photograph of the patient's teeth in the workstation; (b) displaying the color photograph next to one or more digital images of the one or more teeth one or more veneers, crowns or restorations; and (c) providing the one or more digital images of the one or more teeth implants and/or one or more crown implants with color the same as in the digital color photograph of the patient's teeth for manufacturing purposes.

The treatment plan is arrived at using dynamic smile movement whereby smile movement is assessed in multiple directions; or using dynamic jaw movement whereby each jaw is moved in multiple directions.

The method may further comprise the step of overlaying a digital photograph of the patient over the unified three dimensional virtual craniofacial and dentition model of the patient thereby enabling simulation of a layered facial views of the patient; wherein the layered facial views comprise digital facial photographic view, three dimensional facial soft tissue view, three dimensional facial bones, teeth and gingiva view, wherein the teeth view comprises view of three dimensional crowns and three dimensional roots; upper jaw and lower jaw moving view; bite view; and simply three dimensional teeth view; wherein the layered facial views can be rotated and/or translated in desired directions.

In another embodiment of the invention, a system for planning comprehensive treatment of a patient, having a malocclusion and one or more craniofacial and/dentition abnormalities requiring surgery, by a practitioner, is described comprising:

(a) a workstation comprising a processor, a storage medium, and a graphical user interface;

(b) a volume scanning device scanning as-is anatomy of craniofacial and dentition structures of the patient; and

(c) a surface scanning device scanning upper and lower gingiva of the patient;

wherein the storage medium stores digitized records pertaining to the patient, the digitized records including image data obtained from scanning by the volume scanning device and the surface scanning device;

wherein the storage medium further stores a set of software instructions providing graphical user interface tools for access and display of the digitized records;

wherein the storage medium provides software instructions for constructing and display of a unified three dimensional virtual craniofacial and dentition model of the patient from digital data obtained from the volume scanning device; wherein the unified three dimensional virtual craniofacial and dentition model comprises:
(i) facial bone structure including upper jaw and lower jaw;
(ii) facial soft tissue; and
(iii) teeth including crowns and roots; wherein the roots are positioned relative to each other and relative to bones of the upper jaw and bones of the lower jaw;

wherein the storage medium provides software instructions for constructing virtual models of upper and lower gingiva of the patient from digital data obtained from the surface scanning device;

wherein the storage medium further provides software instructions enabling an user separate one or more elements from (i), (ii), (iii), and upper and lower gingiva as true anatomical object(s) of the patient, as desired;

wherein the storage medium further stores treatment planning instructions enabling the practitioner to:
(i) examine the unified three dimensional virtual craniofacial and dentition model of the patient;
(ii) identify one or more abnormalities requiring surgery for removing the one or more abnormalities in the patient's craniofacial and/dentition;
(iii) create a post-surgery desired setup of the patient's teeth, including movements of one or more of the teeth and movements of the teeth within the bone structure, for curing the malocclusion;
(iv) create a pre-surgical setup of the patient's teeth while retaining the movements of one or more of the teeth, but removing the movements of the teeth within the bone structure; both from the post-surgery desired setup;
(v) adjust the movements of one or more of the teeth in the pre-surgical setup thereby allowing room for the surgery for removing the one or more abnormalities; and creating adjusted pre-surgical setup;
(vi) design orthodontic appliances for the patient in accordance with the adjusted pre-surgical setup; and
(vii) design orthodontic appliances for the patient in accordance with the post-surgical setup.

The volume scanning device can be either a cone beam computed tomographic (CBCT) scanner, or an ultra-sound scanner, or a magnetic resonance imaging (MRI) scanner; and the surface scanning device either an in-vivo scanner, or a laser scanner.

The dentition of the patient includes one or more orthodontic appliances attached to the dentition. The orthodontic appliances include one or more orthodontic brackets bonded to the teeth; on the basis of one bracket per tooth.

In yet another embodiment of the invention, a method of orthodontic treatment planning for a patient having tooth-roots abnormalities, using a workstation having a processing device, a storage device, and an user interface with a display, is disclosed. The method comprises the steps of:

(a) obtaining a three dimensional virtual model of dentition of the patient; wherein the virtual model of dentition is constructed solely from volume scanned digital images of actual craniofacial and dentition structure of the patient, and comprises the patient's teeth with three-dimensional crowns and three-dimensional roots and three-dimensional upper and lower jaw bones;

(b) identifying the tooth-roots abnormalities; and

(c) planning corrective treatment steps to cure the tooth-roots abnormalities.

The tooth-roots abnormalities comprise one or more tooth-roots entangled with one or more different tooth-roots; and wherein the corrective treatment steps comprise repositioning the teeth in a step-wise manner such that the treatment steps enable un-entangling of the tooth-roots. The tooth-roots abnormalities may comprise one or more tooth-roots or portion(s) thereof which are placed out-side of the upper or lower jaw bones of the patient as applicable; and wherein the corrective treatment steps comprise repositioning the teeth, in a step-wise manner, such that the tooth-roots are completely contained in such bones as desired.

The upper and lower gingiva are integrated within the three dimensional virtual craniofacial and dentition model of the patient; and wherein shape of the upper and lower gingiva is adjusted as desired thereby enabling curing the tooth-roots abnormalities.

The orthodontic appliances are designed for assisting in curing the tooth-roots abnormalities. The orthodontic appliances include one or more orthodontic brackets; one or more sets of aligners; one or more orthodontic archwires.

A facial digital photograph of the patient may be included to further enable treatment planning.

In yet another embodiment of the invention, a method of orthodontic treatment planning for a patient having tooth-appearance abnormalities, tooth shape anomalies, fractured anatomy, loss of structure, or loss of tooth is disclosed. The method is based upon using a workstation having a processing device, a storage device, and an user interface with a display. The method comprises the steps of:

(a) obtaining a three dimensional virtual model of dentition of the patient; wherein the virtual model of dentition is constructed solely from volume scanned digital images of actual craniofacial and dentition structure of the patient, and comprises the patient's teeth with three-dimensional crowns and three-dimensional roots and three-dimensional upper and lower jaw bones;

(b) identifying the tooth-appearance abnormalities; and

(c) planning corrective restorative treatment steps to cure the tooth-appearance abnormalities;

(d) planning corrective restorative and implant treatment to cure the loss of teeth.

The tooth-appearance abnormalities comprise one or more teeth of the patient having sizes smaller than desired; and wherein the corrective treatment steps are to increase the size or change form of each of the one or more teeth to the desired size; or one or more teeth of the patient having sizes larger than desired; and wherein the corrective treatment steps are to decrease the size or form of each of the one or more teeth to the desired size; or one or more teeth of the patient having shapes other than desired; and wherein the corrective treatment steps are to reshape each of the one or more teeth to the desired shape; or one or more teeth of the patient having undesirable sizes and shapes; and wherein the corrective treatment steps are to resize and reshape each of the one or more teeth to the desired size and shape; or one or more teeth of the patient having one or more line angles misplaced on the one or more teeth; and wherein the corrective treatment steps are to properly restore each of the one or more of line angles; or one or more teeth of the patient having one or more points misplaced on the one or more teeth; and wherein the corrective treatment steps are to properly place each of the one or more misplaced points.

The tooth anatomy, size and form can be restored based upon a template tooth from a library of the template teeth; or based upon a similar tooth in the patient's mouth; based upon a mirror image of the non-affected side of the tooth of the patient.

A method of orthodontic treatment planning for a patient having tooth-appearance abnormalities, tooth shape anomalies, fractured anatomy, loss of structure, loss of tooth using a workstation having a processing device, a storage device, and an user interface with a display, comprising the steps of:

(a) obtaining a three dimensional virtual model of dentition of the patient; wherein the virtual model of dentition is constructed from surface scanned in-vivo and/or invitro digital images of actual dentition structure of the patient, and comprises the patient's teeth with three-dimensional crowns;

(b) identifying the tooth-appearance abnormalities, tooth shape anomalies, fractured anatomy, loss of structure, loss of tooth;

(c) planning corrective treatment steps to cure the tooth-appearance abnormalities, tooth shape anomalies, fractured anatomy, loss of structure, loss of tooth;

(d) designing device to correct the tooth-appearance abnormalities, tooth shape anomalies, fractured anatomy, loss of structure, loss of tooth; and

(d) sending data to a manufacturing device.

In yet another embodiment of the invention, a method of orthodontic treatment planning for a patient having soft tissue abnormalities, is disclosed. The method is based upon using a workstation having a processing device, a storage device, and an user interface with a display. The method comprises the steps of:

(a) obtaining a three dimensional virtual model of soft tissue of the patient; wherein the virtual model of soft tissue is constructed from volumetric and/or surface scanned in-vivo and/or invitro digital images of actual soft tissue structure of the patient;

(b) identifying the soft tissue abnormalities;

(c) planning corrective treatment steps to cure the soft tissue abnormalities;

(d) designing device to correct the soft tissue abnormalities; and

(d) sending data to a manufacturing device.

In yet another embodiment of the invention, a method of planning treatment for a patient having one or more root abnormalities, is disclosed. The method is based upon using a workstation having a processing device, a storage device, and an user interface with a display. The method comprises the steps of:

(a) obtaining a three dimensional virtual model of teeth with crowns and roots, bone, soft tissue, e.g., gingival tissue, of the patient; wherein the virtual model of virtual model of teeth with crowns and roots, bone and soft tissue is constructed from volumetric scanned data and/or surface scan data of the patient;

(b) diagnosing the root abnormalities;
wherein the diagnosed root abnormalities have an impact on:
   (i) one or more other roots; and/or
   (ii) bone; and/or
   (iii) soft tissue;

(c) planning corrective treatment steps to cure the diagnosed root abnormalities; wherein the corrective treatment steps comprise one or more of the following: (A) orthodontic treatment, (B) surgical treatment, (C) periodontal treatment, (D) endodontic treatment, and (E) restorative treatment;

(d) designing one or more devices to correct the root abnormalities; and

(e) sending data to a facility for manufacturing the one or more devices.

In yet another embodiment of the invention, a method of planning treatment for a patient having one or more alveolar bone abnormalities or defects, is disclosed. The method is based upon using a workstation having a processing device, a storage device, and an user interface with a display. The method comprises the steps of:

(a) obtaining a three dimensional virtual model of bone, teeth with crowns and roots, and/or soft tissue, e.g., gingival tissue, of the patient; wherein the virtual model is constructed from volumetric scanned data and/or surface scan data of the patient;

(b) diagnosing the bone defects and abnormalities;
wherein the diagnosed bone abnormalities and/or defects have an impact on:
   (i) one or more roots; and/or
   (ii) soft tissue; and/or
   (iii) adjacent bone;

(c) planning corrective treatment steps to cure the diagnosed bone abnormalities and/or defects; wherein the corrective treatment steps comprise one or more of the following: (A) orthodontic treatment, (B) surgical treatment, (C) periodontal treatment, (D) restorative treatment, (E) endodontic treatment, and (F) prosthodontic treatment;

(d) designing one or more devices to correct the bone abnormalities and/or defects; and

(e) sending data to a facility for manufacturing the one or more devices.

In yet another embodiment of the invention, a method of planning treatment for a patient having one or more gingival tissue abnormalities or defects, is disclosed. The method is based upon using a workstation having a processing device, a storage device, and an user interface with a display. The method comprises the steps of:

(a) obtaining a three dimensional virtual model of bone, teeth with crowns and roots, and/or soft tissue, e.g., gingival tissue, of the patient; wherein the virtual model is constructed from volumetric scanned data and/or surface scan data of the patient;

(b) diagnosing the gingival defects and abnormalities;
wherein the diagnosed gingival abnormalities and/or defects have an impact on:
   (iv) one or more roots; and/or
   (v) adjacent soft tissue; and/or
   (vi) bone; and/or tooth crown

(c) planning corrective treatment steps to cure the diagnosed gingival abnormalities and/or defects; wherein the corrective treatment steps comprise one or more of the following: (A) orthodontic treatment, (B) surgical treatment, (C) periodontal treatment; (D) restorative treatment;

(d) designing one or more devices to correct the gingival abnormalities and/or defects; and

(e) sending data to a facility for manufacturing the one or more devices.

In yet another embodiment of the invention, a method of planning treatment for a patient having one or more craniofacial and/or dental abnormalities or defects, is disclosed. The method is based upon using a workstation having a processing device, a storage device, and an user interface with a display. The method comprises the steps of:

(a) obtaining a three dimensional virtual model of craniofacial and dentition structures of the patient; wherein the virtual model is constructed from volumetric scan data and/or surface scan data of the patient;

(b) diagnosing the abnormalities and/or defects;
wherein the diagnosed abnormalities and/or defects require a combination of one or more treatment types;
wherein the treatment types comprise one or more from the following treatment types; (A) orthodontic, (B) oral surgery, (c) restorative dentistry, (d) periodontal surgery, (E) endodontics, (F) plastic surgery, etc.

(c) evaluating different treatment options from the view point of:
(i) treatment priority;
(ii) patient desires;
(iii) doctor skills;
(iv) timeliness of care;
(v) treatment cost;
(vi) degree of invasiveness;
(vi) effectiveness;

(c) planning corrective treatment steps to cure the diagnosed gingival abnormalities and/or defects; wherein the corrective treatment steps comprise one or more of the following: (A) orthodontic treatment, (B) surgical treatment, (C) periodontal treatment; (D) restorative treatment;

(d) designing one or more devices to correct the gingival abnormalities and/or defects; and

(e) sending data to a facility for manufacturing the one or more devices.

In yet another embodiment of the invention, a method of training, skill enhancements and skill assessment for treatment planning is disclosed. The method comprises the steps of:

(a) treating patients with diversity of problems;

(b) simulating treatment options;

(c) evaluating treatment options against standardized library of treatment simulations.

In yet another embodiment of the invention, a method of registering bite of the upper jaw and the lower jaw of a patient, with the accompanying teeth is disclosed. The method comprises the steps of:

(a) capturing three dimensional volumetric scan of the cranio facial and dentofacial complex of the patient;

(b) obtaining an in-vivo and/or invitro bite scan of the patient's dentition using surface scanning;

(c) registering the three dimensional volumetric scan of the cranio facial and dentofacial complex to the patient's the in-vivo and/or invitro bite scan of the dentition obtained from surface scanning.

In yet another embodiment of the invention, a method of registering the upper arch and the lower arch of a patient, with the accompanying teeth with or without roots, with respect to the jaw bones or the facial tissue structure, is disclosed. The method comprises the steps of:

(a) capturing three dimensional volumetric scan of the cranio facial and dentofacial complex of the patient;

(b) defining planes of references anatomical and/or geometrical; and

(c) registering the three dimensional volumetric scan of dentofacial complex with accompanying roots to the patient's facial structure to the user defined reference planes.

In yet another embodiment of the invention, a method of registering the upper arch and the lower arch of a patient, with the crowns accompanying teeth without roots, with respect to 2D images or 3-D images of the jaw bones or the facial tissue structure, is disclosed. The method comprises the steps of:

(a) capturing three dimensional volumetric scan of the craniofacial and dentofacial complex of the patient;

(b) capturing invitro surface data of the dentition of the patient;

(c) defining planes of references anatomical and/or geometrical; and

(d) registering the surface data of the dentition with respect to the patient's jaw bone, and/or facial structure to the user defined reference planes.

In yet another embodiment of the invention, a method of extracting tooth roots from scanning data is disclosed. The method comprises the steps of:
(a) interactively selecting a good threshold value which enables capturing the tooth roots data from the scanning data;
(b) extracting a surface or surfaces identified in step (a), and representing them as triangles;
(c) interactively applying any needed clean-up for removing unwanted data and merging any needed, disconnected fragments;
(d) interactively separating data (triangles) into separate, individual tooth objects; and
(e) interactively, applying any needed clean up to each tooth object.

In yet another embodiment of the invention, a method of extracting bone surface from scanning data is disclosed. The method comprises the steps of:
(a) interactively selecting a good threshold value which captures mandible, maxilla, and potentially, teeth;
(b) extracting the surface or surfaces identified in step (a), representing them as triangles;
(c) interactively applying any needed clean up—remove unwanted data and merge any needed, disconnected fragments;
(d) using boolean (set) operators, subtracting the tooth objects from the extracted surfaces; and
(e) interactively separating the mandible from the maxilla by removing any edges and triangles which connect one to the other.

In order to provide proper consideration of biological constrains during orthodontic treatment planning, the invention disclosed herein provides the following additional elements or steps in the embodiments of the invention disclosed above.
(a) Provide information on bone thickness, bone structural defects, movement of bone in response to movement of teeth and associated movement of teeth roots.
(b) Provide detailed modeling of actual teeth roots to enable proper treatment planning that would prevent roots from penetrating, deforming or fracturing jaw bones and soft tissues.
(c) Provide database for the movement ratio between the teeth and bone and soft tissue collected from industry experiments; and other resources.
(d) Recommend the movement ratio between the teeth and bone and soft tissue for the given patient.
(e) Provide capability to vary the movement ratio between the teeth and bone and soft tissue through treatment simulation to assess the risk factor associated with a particular treatment plan.
(f) Monitor results of the treatment to determine the actual movement ratio between the teeth and bone and soft tissue and update the database.
(g) Provide visual comparison of the defective bone structure and/or soft tissue structure of a patient with normal or optimum bone and tissue structure.

Furthermore, the modeling can be done as 2d shape change or 3d volumetric with time dependency changes in response to tooth movement so such changes can be shown at the soft issue level, or bone level or root level at any level within the structure co dependently or independently. This is very important and each modeling series can be staged as a time specific event. Any modeling change can show subtractive or additive or neutral changes on any surface of interest based upon normative data or nature of tooth movement, appliance, therapy patient sex, plaque index, periodontal condition genetic predisposition, phenotype, morphotype, facial type function. Optimization in the setup includes for the first time an approach that helps plan for minimum tissue destruction and maximum stability in addition to aesthetics and function with maximum efficiency and design of optimal therapeutic devices.

The invention disclosed herein also provides model healing based for any of soft tissue, bone, and root after orthodontic treatment with time dependency and risk factors.

While presently preferred embodiments of the invention have been described for purposes of illustration of the best mode contemplated by the inventors for practicing the invention, wide variation from the details described herein is foreseen without departure from the spirit and scope of the invention. This true spirit and scope is to be determined by reference to the appended claims. The term “bend”, as used in the claims, is interpreted to mean either a simple translation movement of the work-piece in one direction or a twist (rotation) of the work-piece, unless the context clearly indicates otherwise.

1. A method of planning treatment, comprising the steps of:
(a) performing risk evaluation; obtaining three-dimensional surface scanning data of dentition of a patient;
(b) planning treatment;
(c) manufacturing appliances; and
(d) monitoring treatment.
